(19) United States
(12) Patent Application Publication
(10) Pub. No.: US 2026/0292725 A1
(43) Pub. Date: Sep. 24, 2026

(54) RESILIENT NOTIFICATIONS IN NON-TERRESTRIAL NETWORKS

(71) Applicant: InterDigital Patent Holdings, Inc., Wilmington, DE (US)

(72) Inventors: Umer Salim, Vallauris (FR); Moon IL Lee, Melville, NY (US); Dylan Watts, Montreal (CA); Keiichi Kubota, Setagaya-Ku (JP); Brian Martin, Farnham (GB)

(73) Assignee: InterDigital Patent Holdings, Inc., Wilmington, DE (US)

(21) Appl. No.: 19/088,060

(22) Filed: Mar. 24, 2025

(51) Int. Cl. H04W 56/00; H04W 24/08; H04W 72/1273; H04W 72/231; H04W 76/19

(52) U.S. Cl. CPC H04W 56/0015; H04W 24/08; H04W 72/1273; H04W 72/231; H04W 76/19

(57) ABSTRACT

A method may be implemented by a wireless transmit/receive unit (WTRU), including receiving a coverage extended synchronization signal block (eSSB). Based on the receiving of the eSSB a configuration associated with a resilient notification system information block (SIB) window may be determined. A resilient notification SIB may be received during the resilient notification SIB window based on the configuration associated with the resilient notification SIB window. A resilient notification channel may be monitored based on the eSSB and the resilient notification SIB. A resilient notification alert message that comprises an identity of the WTRU may be received via the resilient notification channel.

### BACKGROUND

In Non-Terrestrial Networks (NTNs), coverage limitations may impact downlink (DL) communications. Prior to Release 19 (Pre-R19), simulations conducted for Third Generation Partnership Project (3GPP) Releases 16 and 17 (R-16 and R-17) may have primarily considered Line-of-Sight (LoS) scenarios. For coverage enhancement, Release 18 (R-18) may have initially introduced Non-Line-of-Sight (NLoS) scenarios; however, NLoS-related work may have been deprioritized.

### SUMMARY

A wireless transmit/receive unit (WTRU) may include a processor. The processor may be configured to receive a coverage extended synchronization signal block (eSSB) and to determine a configuration associated with a resilient notification system information block (SIB) window based on the receiving of the eSSB. The processor may be configured to receive a resilient notification SIB during the resilient notification SIB window based on the configuration associated with the resilient notification SIB window, monitor a resilient notification channel based on the eSSB and the resilient notification SIB and receive, via the resilient notification channel, a resilient notification alert message that comprises an identity of the WTRU.

The eSSB may be a coverage-extended SSB based on a normal SSB structure that is transmitted with one or more of a shorter periodicity, additional repetitions, or a modified transmission pattern as compared to a normal SSB.

The processor may be configured to receive configuration information associated with the eSSB based on one or more of a previously stored configuration, neighbor cell information, or upon failure to detect a coverage-resume signal.

The processor may be configured to determine a subframe number, a control resource set (CORESET), or a search space (SS) based on the eSSB, wherein the configuration of the resilient notification SIB window is based on one or more of the subframe number, the CORESET, or the SS.

The configuration associated with the resilient notification SIB window may indicate one or more of a periodicity of the resilient notification SIB window, a duration of the resilient notification SIB window, a CORESET associated with the resilient notification SIB window, a search space associated with the resilient notification SIB window, physical downlink control channel (PDCCH) repetition and combining parameters associated with the resilient notification SIB window, or physical downlink shared channel (PDSCH) repetition and combining parameters associated with the resilient notification SIB window.

The processor may be configured to determine that the resilient notification SIB is transmitted in a physical downlink control channel (PDCCH) during the resilient notification SIB window based on one or more of PDCCH repetition and combining parameters, or physical downlink shared channel (PDSCH) repetition and combining parameters, as provided by the configuration associated with the resilient notification SIB window, wherein the resilient notification SIB window comprises a plurality of PDCCH occasions.

The processor may be configured to determine the configuration associated with the resilient notification SIB window after failing to detect any normal SSB or after failing to camp on any cell.

The resilient notification SIB may include a resilient notification monitoring configuration. The processor may be configured to monitor the resilient notification channel based on the resilient notification monitoring configuration, wherein the resilient notification monitoring configuration comprises one or more of a periodicity for resilient notification alert monitoring, a CORESET associated with the resilient notification channel, a search space for resilient notification monitoring, or physical downlink control channel (PDCCH) repetition parameters for resilient notification alert reception.

The processor may be configured to receive a physical downlink control channel (PDCCH) associated with the resilient notification SIB, receive scheduling information for a physical downlink shared channel (PDSCH) associated with the resilient notification SIB by decoding the PDCCH, receive the PDSCH based on the scheduling information, receive a resilient notification monitoring configuration from the PDSCH, and monitor for resilient notification alerts based on the resilient notification monitoring configuration.

The resilient notification channel may be one or more of a physical downlink control channel (PDCCH) or a physical downlink shared channel (PDSCH) based upon the configuration received in the resilient notification SIB. The resilient notification SIB may indicate uplink resources for use by the WTRU, wherein the uplink resources may include physical random access channel (PRACH) or physical uplink control channel (PUCCH) resources to enable the WTRU to respond to the resilient notification alert messages.

A method may be implemented by a wireless transmit/receive unit (WTRU), including receiving a coverage extended synchronization signal block (eSSB). Based on the receiving of the eSSB a configuration associated with a resilient notification system information block (SIB) window may be determined. A resilient notification SIB may be received during the resilient notification SIB window based on the configuration associated with the resilient notification SIB window. A resilient notification channel may be monitored based on the eSSB and the resilient notification SIB. A resilient notification alert message that comprises an identity of the WTRU may be received via the resilient notification channel.

The eSSB may be a coverage-extended SSB based on a normal SSB structure that is transmitted with one or more of a shorter periodicity, additional repetitions, or a modified transmission pattern as compared to a normal SSB.

The method may include receiving configuration information associated with the eSSB based on one or more of a previously stored configuration, neighbor cell information, or upon failure to detect a coverage-resume signal.

The method may include determining one or more of a subframe number, a control resource set (CORESET), or a search space (SS) based on the eSSB, wherein the configuration of the resilient notification SIB window is based on one or more of the subframe number, the CORESET, or the SS.

The configuration associated with the resilient notification SIB window may indicate one or more of a periodicity of the resilient notification SIB window, a duration of the resilient notification SIB window, a CORESET associated with the resilient notification SIB window, a search space associated with the resilient notification SIB window, physical downlink control channel (PDCCH) repetition and combining parameters associated with the resilient notification SIB window, or physical downlink shared channel (PDSCH) repetition and combining parameters associated with the resilient notification SIB window.

The method may include determining that the resilient notification SIB is transmitted in a physical downlink control channel (PDCCH) during the resilient notification SIB window based on one or more of PDCCH repetition and combining parameters, or physical downlink shared channel (PDSCH) repetition and combining parameters, as provided by the configuration associated with the resilient notification SIB window, wherein the resilient notification SIB window comprises a plurality of PDCCH occasions.

The method may include determining the configuration associated with the resilient notification SIB window after failing to detect any normal SSB.

The resilient notification SIB may include a resilient notification monitoring configuration. The method may include monitoring the resilient notification channel based on the resilient notification monitoring configuration, wherein the resilient notification monitoring configuration comprises one or more of a periodicity for resilient notification alert monitoring, a CORESET associated with the resilient notification channel, a search space for resilient notification monitoring, or physical downlink control channel (PDCCH) repetition parameters for resilient notification alert reception.

The method may include receiving a physical downlink control channel (PDCCH) associated with the resilient notification SIB, receiving scheduling information for a physical downlink shared channel (PDSCH) associated with the resilient notification SIB by decoding the PDCCH, receiving the PDSCH based on the scheduling information, receiving a resilient notification monitoring configuration from the PDSCH; and monitoring for resilient notification alerts based on the resilient notification monitoring configuration.

The resilient notification channel may be one or more of a physical downlink control channel (PDCCH) or a physical downlink shared channel (PDSCH) based upon the resilient notification SIB. The resilient notification SIB may indicate uplink resources for use by the WTRU, wherein the uplink resources may include physical random access channel (PRACH) or physical uplink control channel (PUCCH) resources to enable the WTRU to respond to the resilient notification alert messages.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a graph illustrating an example signal characteristic or performance metric related to resilient notification (RN) alerts according to an embodiment.

FIG. 3 is a diagram illustrating an example method for receiving resilient notification (RN) alerts according to an embodiment.

FIG. 4 is a diagram illustrating an example structure of a synchronization signal block (SSB) according to an embodiment.

FIG. 5 is a diagram illustrating an example method for receiving resilient notification (RN) alerts with an alternative configuration according to an embodiment.

FIG. 6 is a diagram illustrating an example method for detecting and/or decoding resilient notification alerts is illustratively depicted according to an embodiment.

### DETAILED DESCRIPTION

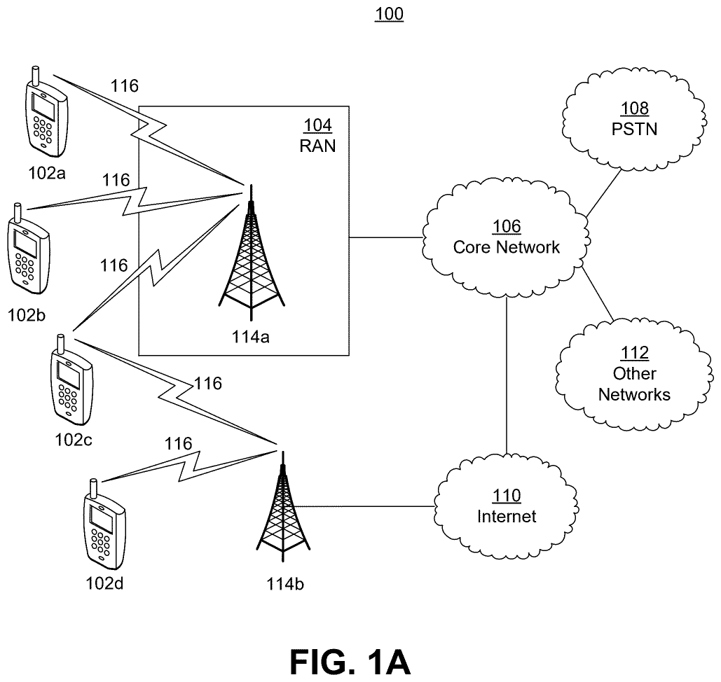

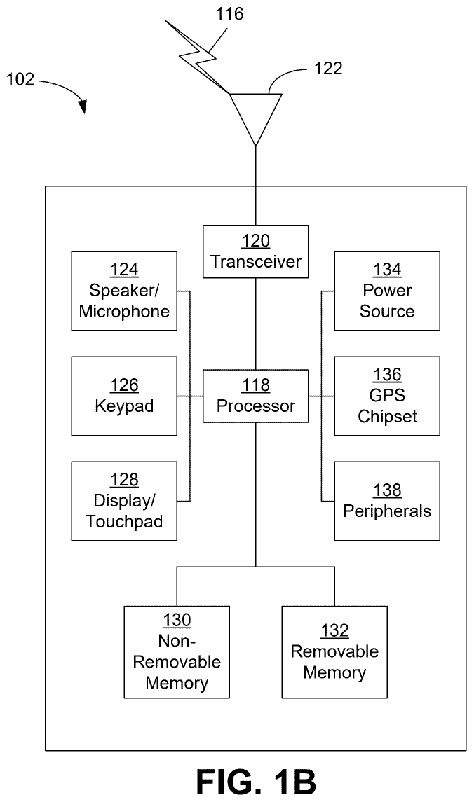

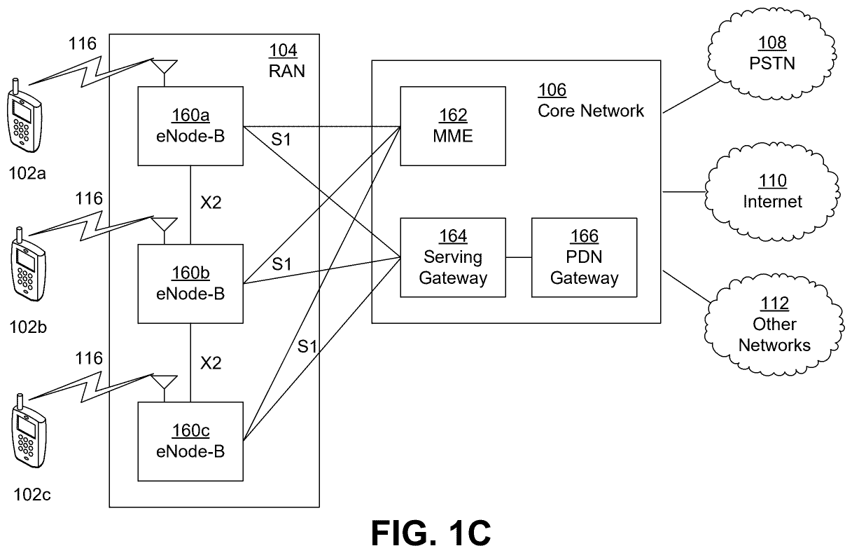

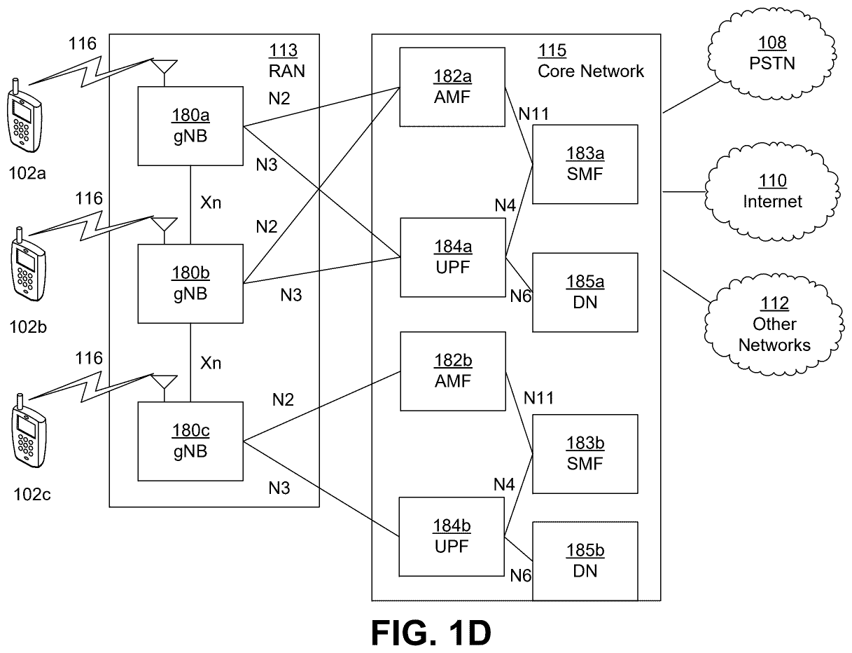

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A resilient notification alert may indicate to a Wireless Transmit-Receive Unit (WTRU) that there may be missed incoming calls and/or messages when the WTRU may not be reachable. The resilient notification alert may provide limited information to the WTRU, which may include the type of service attempting to reach the WTRU, caller identification, and/or basic text.

A WTRU may receive and decode coverage-extended resilient notification (RN) system information to monitor resilient notifications based upon a detected SSB and/or an extended coverage SSB (eSSB). The WTRU may register to receive resilient notifications based upon the received RN system information.

A WTRU may determine an RN configuration based upon a detected legacy SSB and monitor the RN channel accordingly. Similarly, the WTRU may determine an RN configuration based upon a detected coverage-extended SSB and monitor the RN channel. In some cases, the WTRU may determine the RN configuration based upon a detected SSB and/or eSSB in combination with an RN SIB.

A WTRU may receive short message-based RN notifications. The WTRU may decode an RN PDCCH based upon the RN monitoring configuration and determine an RN alert based upon an assigned short message bit. In some cases, the WTRU may receive an RN alert based upon detecting its assigned bit in an RN PDSCH bitmap.

A WTRU may receive a full RN paging message alert. The WTRU may monitor and decode an RN PDCCH based upon the RN configuration to receive the scheduling information for an RN PDSCH. The WTRU may then decode the RN PDSCH based upon the scheduling information received in the RN PDCCH. The WTRU may perform PDSCH repetition combining based upon the RN monitoring configuration and/or indications received in the decoded PDCCH.

A WTRU may operate in poor Signal-to-Noise Ratio (SNR) conditions where legacy paging may not be reachable. Upon reception of a resilient notification alert, the WTRU may determine whether to move to a location with improved signal reception for communication, based on user cooperation. A WTRU may be categorized as a cooperative user if the WTRU may be capable of improving its coverage condition based on the reception of a simple notification, such as a ping to the WTRU. A cooperative user may decide to improve coverage based on the limited information received through the resilient notification alert. A cooperative user may take one or more actions to improve coverage, which may include stepping outside a building, removing the WTRU from a pocket and/or bag, orienting the WTRU in a direction favorable for signal reception, such as toward a satellite, moving out of a dense forested area, and/or traveling to a location with network connectivity.

3GPP may define simulation scenarios and associated parameters for various NTN settings. Mean values for K-Factor, which may represent the ratio of the power of the direct LoS path to the power of scattered paths, may be established for different elevation angles from the user to the satellite. The following values may be extracted from Technical Report (TR) 38.811. For the S band (2 GHz) in a LoS suburban scenario, the mean K-factor may be 11.4 dB at a 10-degree elevation angle and 20.8 dB at a 30-degree elevation angle. For the Ka band (20 GHz) in a LoS suburban scenario, the mean K-factor may be 8.9 dB at a 10-degree elevation angle and 11.3 dB at a 30-degree elevation angle. For the S band in a rural LoS scenario, the mean K-factor may be 24 dB at a 10-degree elevation angle and 8 dB at a 30-degree elevation angle. For the Ka band in a rural LoS scenario, the mean K-factor may be 25 dB at a 10-degree elevation angle and 8 dB at a 30-degree elevation angle.

The simulation results may indicate that NTN signals may exhibit a strong LoS component across different channels. When LoS conditions may not be available, received power levels for NTN user equipment (UEs) may be significantly lower than the levels for which the NTN system, including signals and/or channels, may be designed.

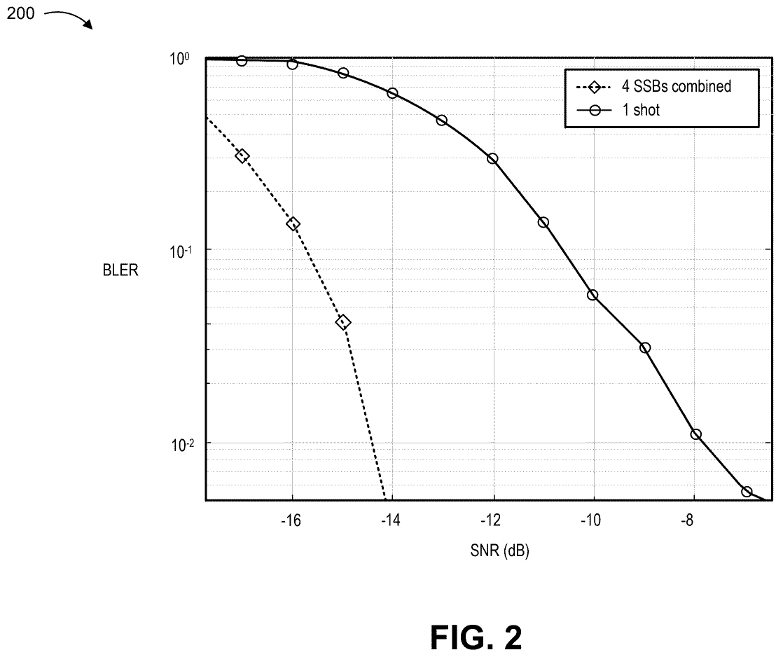

Referring now to FIG. 2, a graph 200 showing an example performance of Synchronization Signal Block (SSB) detection in a Non-Terrestrial Network (NTN) is illustratively depicted. The graph shows the Block Error Rate (BLER) of Physical Broadcast Channel (PBCH) detection as a function of Signal-to-Noise Ratio (SNR), assuming perfect Primary Synchronization Signal (PSS) and Secondary Synchronization Signal (SSS) search and synchronization. The Carrier-to-Noise Ratio (CNR) values for downlink (DL) reference scenarios in Release 19 (Rel-19) may be: −1.8 dB for Set 1-1 and Set 1-2, and −9.8 dB for Set 1-3.

The required SNR for SSB detection, based on the graph, may be −14.4 dB and −15.7 dB for a 4-SSB combined scenario at 1% and 10% BLER, respectively, and −8 dB and −10.6 dB for a single-shot SSB scenario at 1% and 10% BLER, respectively. Current results may indicate that single-shot SSB performance may be insufficient for lower capability satellites, such as Set 1-3, while more capable satellites, such as Set 1-1 and Set 1-2, may have a margin of approximately 6 dB. The performance results may be applicable to Line-of-Sight (LoS) channel conditions, and a degradation of approximately 8-10 dB may be expected in Non-Line-of-Sight (NLoS) conditions. In certain scenarios, NLoS degradation may range from 15 dB to 25 dB.

SSB single-shot detection may become the norm in NTNs with higher SSB periodicities. Satellites may use narrow beams for SSB and data transmission, and if wide beams are used for SSB and System Information Blocks (SIBs), a performance degradation of approximately 3-6 dB may be expected for SSB detection.

If an NTN deployment considers the support of a resilient notification channel, the target may be to allow the reception of resilient notifications at an SNR degradation of 10 to 25 dB compared to typical NTN LoS operation conditions. In such extreme coverage conditions, a WTRU may not be able to detect and/or decode any SIB in the DL direction. In certain extreme conditions, UEs may not be able to detect SSBs, leaving the UEs without any time-frequency reference. In such extreme coverage conditions, location services (e.g., GNSS) may also be heavily compromised.

A problem in NTN deployments may involve the design of a resilient notification channel and/or procedure for scenarios where UEs may not be able to detect system information and/or DL synchronization (e.g., time-frequency reference and/or SSB) through legacy means.

A simple approach for resilient notifications reaching extreme coverage may involve blindly transmitting DL notifications with a large number of repetitions. However, such an approach may introduce resource overhead, may negatively impact energy efficiency, and may result in a limited probability that UEs in poor coverage conditions may receive notifications, despite a large number of repetitions, due to the absence of system information and/or synchronization.

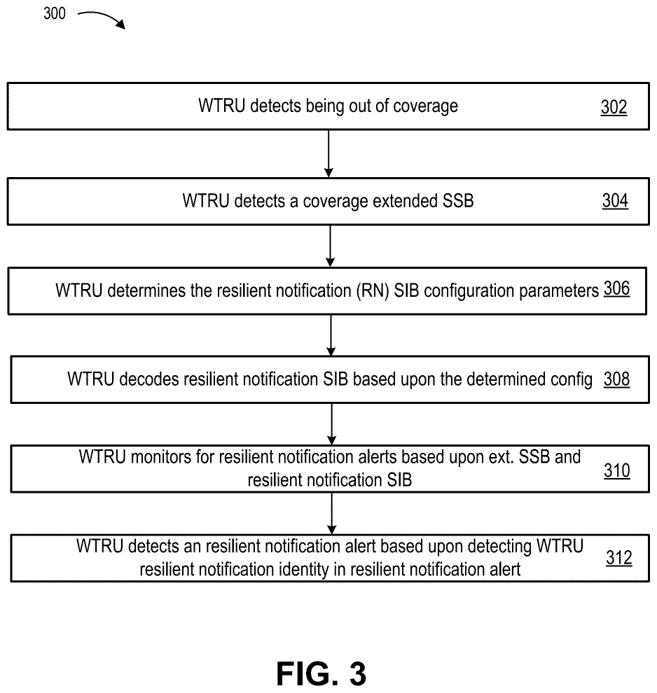

Referring now to FIG. 3, a diagram of an example method 300 for receiving resilient notification (RN) alerts is illustratively depicted.

At 302, the WTRU may detect being out of coverage. At 304, the WTRU may detect a coverage-extended Synchronization Signal Block (eSSB). At 306, the WTRU may determine the resilient notification (RN) System Information Block (SIB) configuration parameters. At 308, the WTRU may decode the resilient notification SIB based on the determined configuration. At 310, the WTRU may monitor for resilient notification alerts based on the extended SSB and resilient notification SIB. At 312, the WTRU may detect a resilient notification alert based on detecting the WTRU RN identity in a received resilient notification alert.

In examples, a WTRU may acquire an extended coverage synchronization signal block (eSSB) after failing to detect any normal SSB. Based upon the timing (System Frame Number (SFN)) and Master Information Block (MIB) contents within the eSSB, the WTRU may acquire an extended coverage resilient notification (RN) system information block (SIB). Based upon the eSSB and the resilient notification SIB, the WTRU may monitor and receive resilient notifications.

A WTRU may detect a coverage-extended SSB, which may comprise N1 repetitions, either consecutive or with a known shorter periodicity, after failing to detect any normal SSB. The WTRU may attempt to detect an eSSB based upon previous configuration, neighbor cell information, and/or failure to resume coverage detection. Based upon the detected eSSB, which may include SFN, Control Resource Set (CORESET), and/or Search Space (SS), the WTRU may determine the configuration associated with the resilient notification SIB window. The resilient notification SIB window configuration may include parameters such as periodicity, window duration, CORESET, search space, and/or Physical Downlink Control Channel (PDCCH) repetitions and combining parameters. The configuration may include at least N2 consecutive repetitions to allow joint decoding.

A WTRU may decode the resilient notification SIB based upon the determined resilient notification SIB window and N2 combined instances of PDCCH and/or Physical Downlink Shared Channel (PDSCH). The WTRU may monitor the resilient notification channel based upon the eSSB and the resilient notification monitoring configuration received from the resilient notification SIB. The WTRU may decode a resilient notification alert based upon detecting its WTRU identity in the resilient notification alert message.

FIG. 3 illustratively depicts example WTRU actions for receiving resilient notification alerts. The WTRU may acquire resilient notification configuration based upon extended-coverage SSBs. The longer periodicity resilient notification SIB window and consecutive SIB repetitions may allow the WTRU to combine and successfully acquire the resilient notification configuration. The WTRU may perform resilient notification monitoring and reception in extreme conditions without excessive overhead.

A WTRU may support one or a combination of the components described in detail herein below. The following terminology, principles/observations, and benefits may further apply to the examples described herein.

A resilient notification channel refers to a channel meant to be used in downlink coverage-limited areas where, for example, a WTRU may not be able to receive paging or system information or detect SSB via normal means. The terms resilient notification channel, resilient notification, resilient alert, resilient notification alert, notification channel, notification alert/channel, and alert channel may be used interchangeably throughout this document.

A resilient notification refers to a message received and/or transmitted by the WTRU over a resilient notification channel. For example, it may be used to notify the user in coverage-limited areas about missed incoming calls and/or messages when the WTRU is not reachable. In some cases, the resilient notification may provide additional limited information to the user, including the type of service attempting to reach the WTRU, caller information, and/or basic text. The resilient notification may prompt the user to improve channel conditions, for example, through user action. The terms resilient notification, resilient notification alert, notification, notification/alert, and alert may be used interchangeably within this document.

A cooperative user is a WTRU in a poor coverage condition that has improved coverage conditions sufficiently to resume and/or have a likelihood of successfully performing legacy operations, such as receiving paging and/or initiating a normal connection to the network through Random Access Channel (RACH) transmission. Coverage conditions may have improved, for example, due to user actions, such as taking a phone out of a bag, possibly in response to reception of a notification/alert.

A non-cooperative user is a WTRU in a poor coverage condition that has not improved coverage conditions sufficiently to resume and/or have a likelihood of successfully performing legacy operations, such as receiving paging and/or initiating a normal connection to the network through RACH transmission.

The solutions described within highlight the use case of an NTN; however, the solutions described herein may also apply to other networks, such as terrestrial networks, manned and/or unmanned aerial vehicles, and/or communicating cars and/or drones. A resilient notification channel may refer to any type of channel, including a new or existing channel, a PDCCH-based or sequence-based channel, and/or a repetition-based channel, which may be used to support coverage-limited UEs. The resilient notification channel may be downlink-only, may support both uplink and downlink, or may have different channels to support uplink and downlink. The resilient notification channel may exist for direct device-to-device communication, such as a form of sidelink channel between two or more devices. In this case, a device may be able to transmit and/or receive a resilient notification directly to and/or from another one or more devices.

A resilient notification alert may refer to a specific message, or more generally, to any message received by the WTRU over a resilient notification channel. A notification may also be received over a legacy channel and may be distinguished from other legacy messages. Terms such as channel quality or cell quality are intended to describe a metric used to evaluate the strength of the radio quality of the WTRU connection. These metrics may be based on L1 measurements, such as SSB and/or CSI-RS, filtered L3 measurements, such as RSRP and/or RSRQ, or any other measurement or cell quality metric currently defined within Third Generation Partnership Project (3GPP) specifications.

Support of a resilient notification alert channel may improve WTRU operation and reachability in heavily coverage-limited scenarios. Specifically, the solutions described within may offer the following benefits: improved WTRU-to-network synchronization, maximizing the likelihood that the WTRU may remain reachable at times of poor coverage; reduced WTRU signaling overhead due to excessive repeated RACH failure; reduced network signaling overhead due to a lowered probability of paging escalation; and increased WTRU power savings by avoiding unnecessary monitoring of a paging channel that cannot be received successfully.

A WTRU may indicate its capability to operate resilient notification channels. The WTRU may provide its capability indication while the WTRU is camped on a cell, is in a Radio Resource Control (RRC) connected state, or is being released from an RRC connected state. In one example, the WTRU may indicate its capability while performing a Tracking Area Update (TAU) or a Radio Access Network (RAN) notification area update procedure. In one example, the WTRU may indicate its capability to receive a resilient notification channel when out of coverage of normal or legacy cell operation. This may, for example, be achieved by the WTRU transmitting a registration request to receive a resilient notification channel to the network while being out of normal cell coverage.

The WTRU capability indication may be part of the WTRU subscription to a resilient notification alert. If a given WTRU has subscribed to resilient notification alerts, the network may determine, based upon the subscription, that the WTRU is capable of receiving resilient notification alerts.

A WTRU may acquire resilient notification monitoring configuration. The WTRU may receive information and/or configurations to support a resilient notification channel in an NTN. Configurations for a resilient notification channel may be specific to a serving cell and/or satellite or may additionally and/or alternatively be provided for one or more neighboring cells and/or satellites. One or more components of a resilient notification channel configuration may be common to multiple UEs, such as when provided via broadcast signaling, dedicated, and/or group specific. One or more components of a resilient notification channel configuration may apply immediately or may apply at a future time or time period. The information described below may be indicated explicitly, such as via system information, provided via one or more configurations, such as a resilient notification channel configuration, and/or interpreted implicitly, such as via other information, including satellite assistance information contained within ntnConfig.

A WTRU may know, receive, be configured with, or be indicated one or more configurations to receive resilient notification alerts. The WTRU may receive some or all of the parameters of the resilient notification monitoring configurations explicitly or implicitly. In some examples, the WTRU may be pre-configured with a subset of the resilient notification monitoring configuration parameters, while another subset of the parameters may be indicated to the WTRU by the network. In some examples, the WTRU may be pre-configured with a subset of the resilient notification monitoring configuration parameters, and the network may complement or overwrite any set and/or subset of the resilient notification configuration parameters through explicit or implicit indication. In some examples, the WTRU may be pre-configured to determine some of the parameters of the resilient notification monitoring configuration based upon the information received in downlink signals and/or channels, such as SSB and/or eSSB, and/or system information.

A WTRU may receive one or more configurations to receive resilient notification alerts. A resilient notification configuration may comprise one or more of a plurality of parameters, including, for example, the periodicity of resilient notification frames and resilient notification occasions within those frames.

The resilient notification periodicity, T, may indicate the periodicity with which resilient notification frames and resilient notification occasions within those frames repeat. The periodicity may be specified in terms of absolute time, e.g., in the units of milliseconds and/or seconds. In some examples, the periodicity may be specified in terms of the number of radio frames, e.g., system frame number (SFN) and/or hyper-frame numbers (H-SFN). The suitable values of T may be 256 SFN, 512 SFN, 1024 SFN, 2048 SFN, and/or 4096 SFN. In some examples, the WTRU may receive a configuration indicating resilient notification periodicity. In some other examples, the WTRU may be pre-configured to determine the resilient notification periodicity based upon a received signal from the network (e.g., SSB).

The number of resilient notification frames in one resilient notification periodicity, N, may indicate how many resilient notification frames are present in one resilient notification period, T. A resilient notification frame may have a known duration. Resilient notification frame duration may be in terms of absolute time duration or as a function of a radio frame, e.g., comprising one or more SFNs. In one example, one resilient notification frame may be equal to one radio frame.

The offset of a resilient notification frame (e.g., Resilient notification_Offset (RN_Offset)) with respect to a suitable reference (e.g., SFN or H-SFN. RN_Offset) may provide an indication of where the resilient notification frame starts in a given resilient notification period T. In some examples, the WTRU may receive a configuration indicating RN_Offset. In some other examples, the WTRU may be pre-configured to determine the resilient notification periodicity based upon cell timing, e.g., SFN. This may, for example, be the case when the WTRU is able to detect legacy SSB or extended coverage SSB and derive system timing (e.g., SFN). Then, based upon pre-configuration, the WTRU may determine an RN_Offset. In one example, the WTRU may have received a pre-configuration that indicates RN_Offset as SFN=n, where n may have a pre-configured value, e.g., 1, 10, 16, 200, 256, 500, 512, 1000, and/or 1024.

Parameters may include a number (Ns) of resilient notification occasions in one resilient notification frame. A resilient notification configuration may comprise one or more resilient notification monitoring occasions within a resilient notification frame. Ns provides the number of resilient notification monitoring occasions within one resilient notification frame. In one example, there may be only one resilient notification monitoring occasion in a resilient notification frame, and the Ns parameter may not be needed for resilient notification configuration. In some examples, the WTRU may be pre-configured to assume a specific value for Ns.

A validity of a resilient notification configuration may be specified in a resilient notification monitoring configuration which may include a validity specified against time, based upon network area (e.g., based upon a suitable network identity) and based upon location area (e.g., based upon WTRU location). The resilient notification configuration may have a time validity. The resilient notification configuration may have an associated timer, and the WTRU may be configured to consider the configuration valid prior to the expiry of this timer. Network area scope: The resilient notification configuration may have a network area scope associated. The network area scope may indicate a cell ID (e.g., PCI), a PLMN identity, a tracking area identity, and/or a RAN notification area identity. Location area scope: The resilient notification configuration may have a location area scope associated. The location area scope of the resilient notification configuration may be indicated as a reference location for resilient notification configuration and a distance threshold. In some examples, the resilient notification configuration may be valid only in and/or around a specific location or geographic area.

For example, a resilient notification configuration may have a location area scope indicated as being within a 10 km radius for its provided reference geographic coordinates. In some examples, the location area scope may be more involved areas, e.g., polygons. In some examples, the location area scope for the resilient notification configuration may be associated with the WTRU location. For example, a resilient notification configuration may be considered valid in terms of its location area scope if the distance of the WTRU location from a reference resilient notification configuration location is less than a threshold. In some examples, the location area scope of the resilient notification configuration may be associated with the cell and/or beam location from which the WTRU is receiving the signals. As an example, if the distance between the resilient notification configuration reference location and the cell and/or beam reference location is less than the distance threshold, the resilient notification configuration is valid within this cell and/or beam.

The WTRU may be configured with a resilient notification CORESET and a resilient notification search space to monitor to receive resilient notification alerts. More details on resilient notification CORESET and resilient notification search space are provided in one of the embodiments in this disclosure.

PDCCH repetitions and combining: The WTRU may be configured with a configured number of PDCCH repetitions and combining rules/configurations. More details on PDCCH repetitions and combining are provided in one of the embodiments in this disclosure.

A WTRU may receive a resilient notification RNTI to monitor PDCCH associated with resilient notification alerts. The PDCCH may itself be carrying a short message-based alert that may be WTRU-specific or group-specific, and/or the PDCCH may be carrying scheduling-related information for the resilient notification message. In some examples, the resilient notification RNTI may be pre-configured for the WTRU. In some examples, the WTRU may be configured to use the pre-configured resilient notification RNTI as a default RNTI. The WTRU may be configured to monitor resilient notification alerts with the newly received resilient notification RNTI as part of resilient notification configuration. If the WTRU does not receive a resilient notification RNTI from the network, e.g., as part of resilient notification configuration and/or explicitly, the WTRU may be configured to monitor resilient notification alerts using a default resilient notification RNTI.

In some examples, the resilient notification RNTI may be the same as the paging RNTI. In some examples, the WTRU may be configured to use the paging RNTI as the default RNTI to monitor PDCCH associated with resilient notification alerts if it does not receive any specific RNTI to monitor resilient notification alerts.

A WTRU may receive a resilient notification alert type as part of resilient notification configuration. In some examples, the resilient notification alert type may be a configuration parameter separate from resilient notification configuration. The resilient notification alert type may indicate one or more of the following:

In some examples, the resilient notification alert may be a DL-only alert.

In some examples, the resilient notification alert may be both in the DL and in the UL direction (e.g., DL and UL-based alert). The UL alert may be required in the cases when the WTRU may initiate a resilient notification for the network and/or for another device. In some examples, the UL alert may only be transmitted in response to a received DL alert.

In some examples, the resilient notification alert may be based upon a short message (e.g., short message-based alert). A short message-based indication may refer to a bitmap where one of the bits may be assigned to a WTRU. When the WTRU detects the short message bitmap with the WTRU-assigned bit taking a specific value, and/or flipping from its previous value, the WTRU may be configured to detect a resilient notification alert.

In some examples, the resilient notification alert may provide an indication of WTRU identity (e.g., a resilient notification identity, a WTRU identity-based alert). The indication of WTRU identity may be for the complete WTRU identity and/or a truncated/hashed form of WTRU identity. More details on the WTRU identity (e.g., a WTRU resilient notification identity) are disclosed in one of the embodiments in this disclosure.

In some examples, the resilient notification alerts may be WTRU-specific, and the resilient notification alert reception may be based upon a single-shot reception (e.g., single-shot WTRU-specific resilient notification alert).

In some examples, the resilient notification alerts may be group-specific (e.g., targeting a group of WTRUs), and the resilient notification alert reception may be based upon a single-shot reception (e.g., single-shot group-common resilient notification alert).

In some examples, the resilient notification alert reception may be a two-step resilient notification alert reception, where a first step may indicate a group-level resilient notification alert, and a second step may identify the target UEs individually by indicating suitable WTRU identities. In some examples, the first step may indicate the presence of an alert, and the second step may identify either the group and/or the WTRUs.

When a WTRU is configured, indicated, and/or provided with more than one resilient notification configuration, the WTRU may further be indicated with one of those resilient notification configurations for monitoring purposes. The indication of the resilient notification configuration that the WTRU is expected to monitor may be indicated by the network implicitly and/or explicitly. In some examples, the resilient notification configurations may have a priority, and the WTRU may select a configuration with the highest priority to monitor unless explicitly indicated by the network to choose another configuration. In some examples, one of the resilient notification configurations may be indicated as the default configuration. In that case, the WTRU may monitor the default configuration unless the WTRU is indicated a resilient notification configuration to monitor.

The WTRU may be configured to keep its resilient notification configuration valid. The WTRU may receive and update suitable system information blocks to keep its resilient notification configuration valid. This may, for example, be the case when the WTRU is able to receive system information, and the resilient notification configuration is provided as part of the system information.

When the WTRU determines the expiry of its resilient notification configuration, the WTRU stops monitoring resilient notification alerts against the expired resilient notification configuration. In some examples, the WTRU may be configured to select a new resilient notification configuration upon the expiry of its resilient notification configuration. This may, for example, be the case when the WTRU is configured, provided, and/or indicated with more than one resilient notification configuration with different associated validity criteria. In some examples, the WTRU may be configured to provide an indication to the network upon the expiry of its resilient notification configuration. As an example, the WTRU may be configured to re-register for resilient notification alerts and receive a new resilient notification configuration as part of the registration process.

A WTRU may know, receive, be configured with, and/or be indicated a WTRU resilient notification identity against which the WTRU is expected to monitor resilient notification alerts. The WTRU resilient notification identity to monitor resilient notification alerts may be one or more of the following identities:
WTRU resilient notification Identity: A WTRU may be configured, indicated, and/or provided with an explicit WTRU resilient notification identity by the network. In one example, the WTRU may receive a resilient notification identity, and/or a default resilient notification identity, during WTRU subscription to resilient notification alerts. This may, for example, be the case when the WTRU applies for resilient notification subscription from the network, and the WTRU is provided with a default resilient notification identity. In one example, the WTRU may receive a resilient notification identity during the resilient notification monitoring configuration. This may, for example, be the case when the WTRU is expected to register and/or have a handshake with the network prior to monitoring and/or receiving any resilient notification alerts. In these cases, during the registration phase, the network may assign the WTRU an resilient notification identity to monitor. If the WTRU has already received a default resilient notification identity, e.g., during the subscription phase, the WTRU may be expected to monitor resilient notification alerts based upon the newly provided resilient notification identity. In one example, the WTRU may receive a resilient notification RNTI to receive resilient notification alerts. The resilient notification RNTI to receive a resilient notification alert may be WTRU-specific and/or group-specific. The resilient notification RNTI to receive resilient notification alerts may be the same and/or a different RNTI from the RNTI that the WTRU uses to decode the PDCCH associated with the resilient notification alerts.
5G-S-TMSI: A WTRU may be configured to receive resilient notification alerts against its 5G-S-TMSI. This may, for example, be the case when the WTRU receives a 5G-S-TMSI from the network, and the WTRU is configured by the network to use the same identity to monitor resilient notification alerts later while the WTRU is out of coverage. In some examples, the WTRU may be configured to use its last 5G-S-TMSI received from the network to receive resilient notification alerts.
IMSI: A WTRU may be configured to receive resilient notification alerts based upon its IMSI. The WTRU may be configured by the network to use IMSI as a resilient notification identity. In some examples, the WTRU may be expected to receive a suitable resilient notification identity from the network, but if the WTRU does not receive explicitly any identity from the network, and the WTRU finds itself in an extreme coverage situation, the WTRU may be expected to use IMSI as its resilient notification identity (e.g., the WTRU may be expected to monitor resilient notification alerts based upon IMSI).
IMEI: A WTRU may be configured to receive resilient notification alerts based upon its IMEI. The WTRU may be configured by the network to use IMEI as a resilient notification identity.

A bit in a short message bitmap: In some examples, the WTRU may be indicated a bit in a short message bitmap as a WTRU resilient notification identity. This may, for example, be the case when the resilient notification alert is transmitted in the form of a short message, and the WTRU may be configured to detect a resilient notification alert based upon a specific value of the WTRU-assigned bit in the bitmap. As an example, the WTRU may be configured to monitor the n-th bit in the short message bitmap, and a value of ‘1’ for the WTRU-assigned bit may imply a resilient notification alert for the WTRU. In some examples, the WTRU may be indicated a bit in a bitmap as a WTRU group resilient notification identity. This may, for example, be the case when the resilient notification alert is transmitted on a group basis in the form of a short message. The WTRU may be configured to detect a resilient notification alert for its assigned group based upon a specific value of the WTRU-assigned group bit in the bitmap. As an example, the WTRU may be configured to a group and monitor the n-th bit in the short message bitmap, and a value of ‘1’ for the WTRU-assigned group bit may imply a resilient notification alert for the WTRU-assigned group. When the WTRU-assigned group receives an alert, this may imply that at least one of the UEs in this group has an upcoming alert.

In some examples, the UEs may be configured to receive a second-level notification upon receiving a group-level resilient notification alert. The UEs may be configured to receive the second-level notification in a specific format (e.g., in the form of a short message and/or a resilient notification RRC message). In some examples, the UEs may be configured to declare group-specific resilient notification alert reception to the user (e.g., a human user, by showing the alert and/or by playing a sound (e.g., a beep)). In some examples, the UEs may be expected to receive the second-level alert at a later time if the WTRU is able to improve the coverage situation (e.g., if the RSRP values associated with a suitable reference signal (e.g., SSB)) become better than a threshold.

A WTRU's resilient notification identity may have a validity scope. Different types of resilient notification identities may have different validity scopes. As an example, the validity scope of a 5G-S-TMSI may be different from the WTRU's resilient notification identity assigned as a bit in the bitmap. The WTRU's resilient notification identity may have a scope according to one or more of the following:
Time Scope: The WTRU resilient notification identity may have a time scope and/or time validity. The resilient notification identity may have an associated timer, and the WTRU may be configured to consider the identity valid prior to the expiry of this timer.
Network Area Scope: The WTRU resilient notification identity may have a network area scope associated. The network area scope may indicate a cell ID (e.g., PCI), a PLMN identity, a tracking area identity, and/or a RAN notification area identity where the WTRU resilient notification identity is valid. If the WTRU detects itself out of the network area scope associated with its WTRU resilient notification identity, the WTRU may consider the WTRU resilient notification identity invalid.
Location Area Scope: The WTRU resilient notification identity may have a location area scope associated. The location area scope of the WTRU resilient notification identity may be indicated as a reference location for the resilient notification identity and a distance threshold. In some examples, the resilient notification identity may be valid only in and/or around a specific location and/or geographic area.

A resilient notification identity may have a location area scope indicated as within a 10 km radius for the provided reference geographic coordinates. In some examples, the location area scope may be more involved areas (e.g., polygons and/or other shaped area scopes) and/or the location area scope for the resilient notification identity may be associated to the WTRU location. For example, a resilient notification identity may be considered valid in terms of its location area scope if the distance of WTRU location from the reference resilient notification identity location is less than a threshold. In some solutions, the location area scope of the resilient notification identity may be associated to the cell and/or beam location from which the WTRU is receiving the signals. If the distance between resilient notification identity reference location and the cell and/or beam reference location is less than the distance threshold, the resilient notification identity may be valid within this cell and/or beam.

When the WTRU determines the expiry of its WTRU resilient notification identity, the WTRU may stop monitoring resilient notification alerts against the expired WTRU resilient notification identity. In some examples, the WTRU may be configured to select a new resilient notification identity upon the expiry of its resilient notification identity. In one example, if the WTRU resilient notification identity, based upon 5G-S-TMSI and/or a bit of a bitmap, expires, the WTRU may be configured to select its default resilient notification identity (e.g., based upon its resilient notification subscription).

In some examples, the WTRU may be configured to provide an indication to the network upon the expiry of its resilient notification identity. As an example, the WTRU may be configured to re-register for resilient notification alerts and receive a new WTRU resilient notification identity as part of the registration process.

A WTRU may be configured to determine resilient notification frames and/or resilient notification monitoring occasions to monitor for resilient notification alerts. The WTRU may determine when to monitor for resilient notification alerts based upon one or more factors. A WTRU may determine resilient notification frames and resilient notification occasions to monitor resilient notification alerts based upon resilient notification configuration, where a WTRU may be configured to use one or more of the parameters of its resilient notification configuration to determine resilient notification frames and occasions. When the WTRU has more than one resilient notification configuration available, the WTRU may use its selected resilient notification configuration to determine resilient notification frames and occasions. A WTRU resilient notification identity may also be used, where a WTRU may use a suitable resilient notification identity to monitor for resilient notification alerts. The WTRU determination of resilient notification identity is according to one of the embodiments in this disclosure. A WTRU location may be used, where a WTRU may use its location to determine resilient notification frames and occasions to monitor to receive resilient notification alerts.

A reference location for the cell and/or beam through which the WTRU is receiving signals (e.g., SSB) and/or will monitor resilient notification alerts from this cell and/or beam may also be used. The elevation angle of the satellite at the WTRU may be used, where in some solutions, the WTRU may be pre-configured to determine resilient notification frames and occasions from a satellite based upon the elevation angle of the satellite at the WTRU. For example, the WTRU may be pre-configured to determine and monitor resilient notification alerts only if the elevation angle of the satellite is larger than a specified, configured, and/or pre-configured threshold angular value. In some examples, when a WTRU is able to detect more than one satellite, the WTRU may determine to monitor resilient notification alerts from one of the satellites based upon the determined elevation angles for the two satellites. In some examples, the WTRU may be configured to prioritize resilient notification alert reception through a satellite whose elevation angle is closer to the nadir. In some examples, the WTRU may be configured to prioritize resilient notification monitoring from a satellite based upon the elevation and the orbit. Satellite ephemeris data may also be used, where based upon the satellite ephemeris data broadcast in the satellite system information, factors may include the type of the satellite orbit (e.g., LEO, MEO, and/or GEO), the trajectory of the satellite, the service time, the satellite being an earth-moving cell and/or an earth-fixed cell, and whether the satellite is store-and-forward or not. Tracking area and/or RAN notification area may also be used, where a WTRU may use its tracking area and/or RAN notification area to determine resilient notification frames and occasions to receive resilient notification alerts.

A WTRU may determine the resilient notification frame using the following relation:

$$( SFN + RN\_offset ) mod T = {( T / N )}^{⋆} ( WTRU\_RN \_Identity mod N ) ,$$

and the resilient notification occasion based upon the following relation:

$$O\_rs = Floor ( WTRU\_RN \_Identity / N ) mod Ns ,$$

where SFN represents a system frame number to be used as an resilient notification frame, T represents an resilient notification periodicity, N represents the number of resilient notification frames in one resilient notification periodicity, RN_Offset represents the offset of an resilient notification frame with respect to a suitable reference, Ns represents the number of resilient notification occasions in one resilient notification frame, and WTRU_RN_Identity represents a WTRU resilient notification identity to monitor resilient notification alerts. Additional details on the resilient notification configuration parameters and WTRU resilient notification identity are disclosed in different example embodiments described herein.

A WTRU may be configured to determine a resilient notification CORESET to monitor for resilient notification alerts. The WTRU may monitor the resilient notification CORESET instances that fall in the determined resilient notification frame and/or occasions to monitor for resilient notification alerts. In some solutions, the network may configure the WTRU with a resilient notification CORESET to monitor for resilient notification alerts. This may, for example, be the case when the WTRU registers for resilient notification alerts. In some solutions, the network may be broadcasting the resilient notification CORESET configuration to be used for resilient notification monitoring as part of system information. In some solutions, the resilient notification CORESET configuration may be part of the normal cell-level system information, while in some other solutions, the resilient notification CORESET may be broadcast in a resilient notification system information block (SIB), where the transmission of resilient notification SIB is according to one of the embodiments in this disclosure. In some solutions, the resilient notification CORESET configuration may be the same as CORESET 0, and the WTRU may use CORESET 0 configuration to monitor for resilient notification alerts.

This may, for example, be the case when the WTRU has no explicit configuration for resilient notification CORESET. In that case, the WTRU may be configured to use CORESET 0 to monitor for resilient notification alerts. The resilient notification CORESET may be configured as part of the resilient notification monitoring configuration, while in some other examples, the WTRU may be configured separately with the resilient notification CORESET configuration. The WTRU may be configured to determine resilient notification CORESET configuration based upon a detected SSB and/or extended coverage SSB, where the WTRU detection of SSB and/or extended coverage SSB is disclosed in other embodiments described herein. The WTRU may be configured to determine a CORESET to receive resilient notification SIB (e.g., resilient notification SIB CORESET) based upon resilient notification CORESET. The WTRU may be configured to use resilient notification CORESET to receive resilient notification SIB. When this happens, the WTRU may be using a single CORESET to receive resilient notification SIB and/or monitor resilient notification alerts.

A WTRU may be configured to determine a search space (e.g., a resilient notification search space) to monitor for resilient notification alerts. The WTRU may monitor the resilient notification search space instances that fall in the determined resilient notification frame and/or occasions to monitor for resilient notification alerts. The resilient notification search space configuration indicates a CORESET (e.g., a resilient notification CORESET) that this search space is associated with to monitor resilient notification alerts. The resilient notification search space configuration (all or some of the parameters) may be known to the WTRU (e.g., because it may have been pre-specified for all UEs). The resilient notification search space configuration may be one of a set of resilient notification search space configurations. The WTRU may be configured with, indicated, and/or provided with one of the resilient notification search space configurations to monitor for resilient notification alerts. The network may configure the WTRU with a resilient notification search space to monitor for resilient notification alerts. This may, for example, be the case when the WTRU registers for resilient notification alerts.

The WTRU may be configured to determine some or all of the parameters of the resilient notification search space configuration based upon the resilient notification monitoring configuration. For example, the WTRU may be configured to determine the resilient notification search space monitoring periodicity and offset based upon the resilient notification monitoring periodicity and RN_Offset parameters provided as part of the resilient notification monitoring configuration. The network may broadcast the resilient notification search space configuration to be used for resilient notification monitoring as part of system information. The resilient notification search space may be part of normal cell-level system information, while in some cases, the resilient notification search space may be broadcast in a resilient notification system information block (SIB), where the transmission of the resilient notification SIB is according to one of the embodiments in this disclosure.

The WTRU may be configured to determine the resilient notification search space configuration based upon a detected SSB and/or extended coverage SSB, where the WTRU detection of SSB and/or extended coverage SSB is disclosed in other embodiments of this disclosure. The resilient notification search space may be the same as search space 0, and the WTRU may be configured to use the search space 0 configuration to monitor for resilient notification alerts. This may, for example, be the case when the WTRU has no explicit configuration for the resilient notification search space and is able to detect one of the legacy SSB and/or coverage-extended SSB to obtain the information of search space 0. In that case, the WTRU may be configured to use search space 0 to monitor for resilient notification alerts. When the WTRU is configured to monitor resilient notification alerts in search space 0, it may be configured to monitor only the search space instances falling within the WTRU-determined resilient notification frame and/or occasion, where the WTRU determination of resilient notification frame and/or occasion is according to one of the embodiments in this disclosure.

The resilient notification search space may be configured as part of the resilient notification monitoring configuration, while in some cases, the WTRU may be separately configured with the resilient notification search space configuration. The resilient notification search space configuration may provide a periodicity and offset to denote the start of the resilient notification search space to monitor PDCCH for resilient notification alerts (e.g., in absolute time units, in slots of a given SCS, in sub-frame units, and/or other suitable reference units). The periodicity of the resilient notification search space may be aligned to the periodicity of the resilient notification periodicity parameter. The resilient notification search space configuration may provide a duration parameter that indicates the number of instances of the search space in consecutive slots that a WTRU is expected to monitor to receive resilient notification alerts.

When a WTRU is configured and/or indicated to use search space 0 as a resilient notification search space, it may be configured to use a different value for search space duration than the WTRU-determined value for search space 0 duration. When the WTRU is operating in FR1, where search space 0 may indicate two search space sets, the WTRU may be configured to use the first search space set, the second search space set, and/or both for resilient notification monitoring. For a resilient notification search space determined to monitor resilient notification alerts, the WTRU may be configured to perform combining of PDCCH candidates according to configured rules. The WTRU combining of PDCCH in resilient notification search spaces is disclosed in other embodiments in this disclosure.

The WTRU may be configured to determine a search space to receive resilient notification SIB (e.g., a resilient notification SIB search space) based upon a resilient notification search space. In one example, the WTRU may be configured to use the resilient notification search space to receive resilient notification SIB. When this happens, the WTRU may be using a single search space configuration to receive resilient notification SIB and monitor resilient notification alerts.

A WTRU may detect being out of coverage (e.g., being out of normal cell coverage). The WTRU may detect being out of coverage from a prior RRC state of RRC IDLE, RRC CONNECTED, and/or RRC INACTIVE. The WTRU may detect being out of coverage based upon one or more factors, including not detecting any SSB for any cell, detecting an SSB with RSRP below a configured threshold, detecting an SSB but being unable to read system information (e.g., SIB1, SIB19, and/or other relevant SIBs), and/or the cell reselection S criteria not being satisfied for any cell.

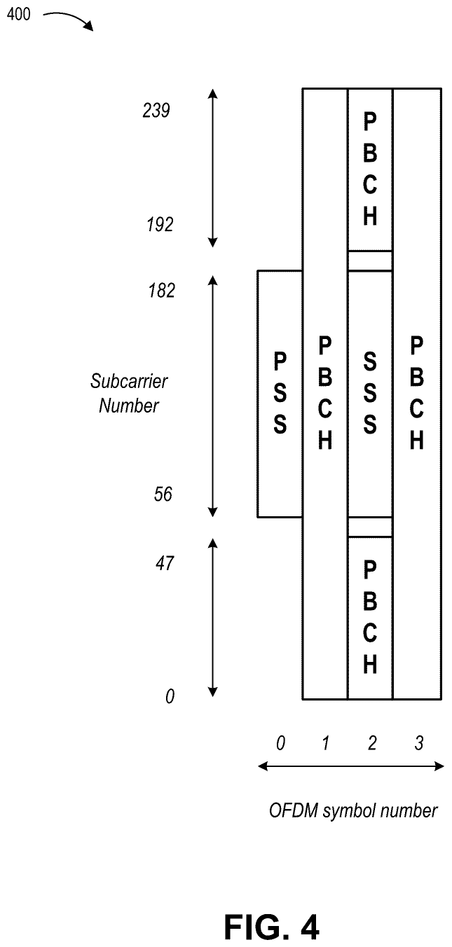

Referring now to FIG. 4, a diagram 400 showing an example structure of a normal synchronization signal block (SSB) (e.g., for 5G NR systems) for resilient notification systems is illustratively depicted.

A WTRU may detect an SSB (e.g., a normal SSB or a legacy SSB). An example of the normal or legacy SSB structure is shown in FIG. 4. The SSB structure may include a consecutive four-symbol, 20 PRB structure, with the first symbol comprising PSS in the middle sub-carriers, the third symbol comprising SSS in the middle sub-carriers, and PBCH multiplexed over the second and fourth symbols and over the extremities of the 20 PRB block in the third symbol. The legacy SSBs have a repetition pattern of an SSB burst within a half-frame (5 ms), where SSBs from different SSB indices are transmitted. The SSBs may be transmitted with a periodicity of 5 ms to 160 ms.

Based upon a detected SSB, the WTRU may determine the cell timing (e.g., SFN), sub-carrier spacing, DMRS for SIB1, PDCCH-configSIB1, cell-barred information, and intra-frequency reselection information. The PDCCH-configSIB1 comprises eight bits in the legacy SSB and uses four bits each to provide CORESET 0 configuration and search space 0 configuration. The WTRU may be configured to detect an extended coverage SSB based upon a detected legacy SSB. The WTRU may be configured to determine resilient notification CORESET and resilient notification search space configurations based upon a detected legacy SSB. The WTRU may be configured to determine PDCCH repetitions and combining for resilient notification monitoring and/or resilient notification SIB reception based upon a detected SSB. This may be based upon an explicit and/or implicit indication from the detected SSB.

A WTRU may be configured to request on-demand resilient notification SIB. The WTRU may be configured to request on-demand resilient notification SIB based upon a detected SSB. The WTRU may receive a configuration, e.g., a RACH configuration, to request on-demand resilient notification SIB. This may be achieved by interpreting differently the information elements within normal SSB, where the WTRU may have been pre-configured to interpret the information elements with normal SSB to request resilient notification SIB.

A WTRU may detect an SSB (e.g., a coverage extended SSB (eSSB)). The WTRU may determine to receive an eSSB based upon one or more factors, including a detected SSB, failing to read system information (e.g., SIB1, SIB19, and/or other relevant SIBs), failing to camp on any cell, and/or the content of a detected SSB (e.g., system timing (SFN)). A coverage extended SSB may be based upon the legacy SSB structure with a modified transmission pattern and/or additional repetitions.

A WTRU may be configured, indicated, and/or expected to receive a coverage extended SSB in one or more forms, including an eSSB based upon the legacy structure with a shorter periodicity, an eSSB based upon the legacy structure with additional repetitions, and/or eSSB repetitions happening at specific timing (e.g., the WTRU may expect a timing window with a very long periodicity (e.g., a hyper-frame and/or multiple of a hyper-frame) where it may receive closely spaced SSB transmissions for joint decoding). A WTRU may be configured, indicated, and/or expected to receive a coverage extended SSB based upon a modified SSB structure. The modified SSB structure may comprise one or more elements, including an eSSB based upon a legacy SSB with s1 additional PSS symbols placed at the beginning of the SSB, at the end of the SSB, and/or partially placed in both the beginning and end; an eSSB based upon a legacy SSB with s2 additional SSS symbols placed at the beginning of the SSB, at the end of the SSB, and/or partially placed in both the beginning and end; an eSSB based upon a legacy SSB preceded by s3 PBCH symbols; and/or an eSSB based upon s4 PSS symbols, s5 SSS symbols, and s6 PBCH symbols. The parameters s1 to s6 are design parameters and may be known to the WTRU (e.g., through specification, pre-configuration, prior configuration, and/or determination by the WTRU based upon a detected SSB and certain known mapping rules).

When a WTRU is expected to monitor and/or detect an eSSB, it may be configured with relevant parameters (e.g., a start time of the eSSB window, a duration of the eSSB window, an offset for the first SSB candidate in the eSSB window, the periodicity of SSBs within the window, a number (e.g., a minimum number) of SSB blocks that the WTRU can combine within the eSSB window, and/or other parameters). When a WTRU is expected to monitor an eSSB, it may receive the relevant parameters associated with eSSB reception, which may facilitate eSSB search and/or detection. The WTRU may receive these relevant parameters through one or more methods, including fixed rules to find an eSSB (e.g., by having knowledge of one or more of the structure, periodicity, an active duration, and/or a window during which eSSBs will be transmitted), prior configurations received by the WTRU while in RRC connected, inactive, and/or idle mode, through specification, through blind decode over a number of hypotheses (where the hypotheses may be known to the WTRU through prior configuration and/or specification), neighbor cell assistance information (where the WTRU may have received the neighbor cell assistance information from one of the neighbor cells), and/or through a legacy SSB (e.g., when the WTRU is able to decode a legacy SSB, and one or more of the elements and/or properties in the detected SSB indicate the presence and/or configuration of a coverage extended SSB). In one example, the WTRU may receive the cell timing (e.g., SFN) through the legacy SSB and may know through other means that the eSSB window may be present and/or start at a certain SFN. The SFN received through the legacy SSB may thus be used to bootstrap the decoding of the eSSB.

A WTRU may also receive relevant eSSB parameters through a detected SSB and mapping rules, and/or as part of the resilient notification monitoring configuration. This may, for example, be the case when the WTRU has been provided with a resilient notification monitoring configuration while being in network coverage. The WTRU may be configured to assume that eSSB transmissions will be aligned with the resilient notification frame and/or occasion as indicated in the resilient notification monitoring configuration. The WTRU may be configured to determine PDCCH repetitions and combining for resilient notification monitoring and/or resilient notification SIB reception based upon a detected eSSB. This may be based upon an explicit and/or implicit indication from the detected eSSB.

A WTRU may be configured to request on-demand resilient notification SIB. The WTRU may be configured to request on-demand resilient notification SIB based upon a detected eSSB. The WTRU may receive a configuration (e.g., a RACH configuration), to request on-demand resilient notification SIB. The information elements within eSSB may provide the configuration to request on-demand resilient notification SIB according to pre-configured mapping principles.

A WTRU may determine a set of parameters associated with the reception of system information necessary to receive resilient notifications. The WTRU may determine one or more parameters to receive system information associated with the reception of resilient notifications, including resilient notification SIB window parameters (e.g., duration, periodicity), resilient notification SIB CORESET and resilient notification SIB search space, PDCCH repetitions and/or combining for the resilient notification SIB search space (where details for PDCCH repetitions and combining are disclosed in one of the embodiments in this disclosure), and/or PDSCH repetitions and combining (e.g., PDSCH repetitions associated with a PDCCH and/or PDSCH repetitions jointly indicated by a combined PDCCH).

The WTRU may determine the parameters associated with the reception of resilient notification SIBs through one or more methods, including through a TN and/or NTN cell while being in coverage of the cell; through a detected SSB (e.g., the WTRU may be configured to determine the CORESET resilient notification SIB based upon CORESET 0 and determine the search space resilient notification SIB based upon search space 0). In one example, the WTRU may be configured to treat CORESET 0 and search space 0 as CORESET resilient notification SIB and search space resilient notification SIB. In some other examples, the WTRU may be configured to apply mapping rules to determine resilient notification SIB CORESET and/or search space based upon parameters in the SSB. The WTRU may also determine the parameters through a detected eSSB. In one design, the eSSB may provide the same PBCH and/or MIB content as the legacy SSB. In that case, the WTRU may be configured to determine the CORESET resilient notification SIB based upon CORESET 0 and determine search space resilient notification SIB based upon search space 0. In another design, the eSSB may broadcast specific information for CORESET resilient notification SIB and search space resilient notification SIB, in which case the WTRU decodes the eSSB and obtains the relevant parameters.

The WTRU may also determine the parameters through a received resilient notification monitoring configuration. If the WTRU has received a resilient notification monitoring configuration and has received and/or determined a resilient notification CORESET and/or resilient notification search space, it may determine a CORESET and a search space to receive resilient notification SIB based upon the resilient notification CORESET and/or resilient notification search space. In one example, the WTRU may be configured to use the resilient notification CORESET as the resilient notification SIB CORESET and use the resilient notification search space as the resilient notification SIB search space. Other possible methods for determining parameters include basing them upon the frequency band of operation, the frequency range (e.g., FR1, FR2, and/or FR3), the sub-carrier spacing of a detected SSB and/or detected eSSB, the sub-carrier spacing common indicated in a detected SSB and/or eSSB, and/or the ARFCN value. The WTRU may also determine the parameter based upon the WTRU request for on-demand resilient notification SIB, and/or based upon the network response to the WTRU request for on-demand resilient notification SIB.

A WTRU may determine the parameters associated with the reception of resilient notification SIBs while being in coverage of a TN and/or NTN cell. The WTRU may, for example, receive the resilient notification SIB relevant parameters when they are broadcast by the cell (e.g., as part of SIB1). A WTRU may determine the parameters associated with the reception of resilient notification SIBs while being out of coverage. In such a case, the WTRU may determine the parameters based upon a detected SSB, a detected eSSB, and/or other means.

Based upon the detected eSSB (and content within), the WTRU may determine the configuration needed to receive a resilient notification SIB, including timing window, CORESET, search space, and/or PDCCH repetitions N2. The eSSB may provide these parameters explicitly by indicating the values in the eSSB (e.g., PBCH within) and/or implicitly where the WTRU may determine the values based upon one or more properties of the eSSB.

A WTRU may be configured to receive resilient notification system information by decoding legacy SIBs (e.g., SIB1, SIB19, and/or other relevant SIBs). This may be the case when the network transmits system information associated with resilient notification as part of the legacy SIBs. When this is the case, the WTRU may first decode SIB1 based upon the CORESET 0 and/or search space 0 configuration received through a detected SSB and/or a detected eSSB. The SIB1 may then lead the WTRU to detect SIB19.

A WTRU may be configured to receive resilient notification system information by decoding a new SIB (e.g., a resilient notification SIB). This may be the case when the network transmits system information associated with resilient notification reception in this new resilient notification SIB. When this occurs, the WTRU may use the resilient notification SIB to obtain the necessary system information for resilient notification reception.

A WTRU may be configured to receive resilient notification system information by decoding PDCCH. This may be the case when the network transmits limited resilient notification system information by embedding the parameters and/or information elements in PDCCH. This may be particularly relevant when the WTRU is expected to receive resilient notification system information while in extreme coverage conditions.

In some examples, the WTRU may determine the parameters to receive resilient notification SIB based upon the WTRU request for on-demand resilient notification SIB. This may for example be the case when the WTRU is configured to request on-demand transmission of resilient notification SIB based upon SSB and/or eSSB. In some examples, the WTRU determination may be based upon the network response to the WTRU request for on-demand resilient notification SIB.

A WTRU may be configured to combine a configured number of PDCCH repetitions when the WTRU is monitoring the PDCCH for resilient notification system information and/or resilient notification alerts. The WTRU may be configured to receive and combine a configured number of PDCCH repetitions through appropriate configuration based upon the type of PDCCH that the WTRU is monitoring. As an example, the WTRU may be configured with PDCCH repetitions and combining to monitor resilient notification alerts as part of the resilient notification monitoring configuration, while the PDCCH monitoring configuration for resilient notification SIB acquisition may be part of the resilient notification SIB configuration. There may be a single configuration for PDCCH repetitions and combining for resilient notification SIB acquisition and resilient notification alerts monitoring.

The WTRU may be configured with a configured number of repetitions for PDCCH. The PDCCH repetitions may be within the resilient notification SIB modification window and/or resilient notification alert frame/occasion. The WTRU may be configured with PDCCH repetitions through search space linkage. For PDCCH monitoring and combining, the WTRU may be configured with any one or more of the following. The WTRU may perform PDCCH combining for inter-slot and/or intra-slot repetitions. The inter-slot and/or intra-slot repetitions for PDCCH may be under the same search space and/or through linked search spaces. The PDCCH combining may be over a configured number of instances of one search space. The PDCCH combining for a configured number of repetitions may be over different search spaces (e.g., when the search space linkage is known to the WTRU, either through fixed relation and/or through configuration). The PDCCH combining may be over the search space instances associated with a given SSB index. This may, for example, be the case when the WTRU is configured to receive PDCCH repetitions for a search space associated with a given SSB index (e.g., search space 0 associated with SSB index x). The PDCCH combining may be over the search space instances associated with different SSB indices. This may, for example, be the case when the WTRU may be configured to combine the PDCCH over search space 0 instances associated with a detected SSB index x and x+1, x+2, and so on. The WTRU may be configured to combine the PDCCH transmitted through the same satellite beam and/or different satellite beams. The WTRU may be configured to combine the PDCCH repetitions received through a single cell and/or TRP and/or the PDCCH repetitions transmitted through different cells/TRPs. Different cells may correspond to two different TN cells, two different NTN cells, two different cells of different NTN orbits, and/or a hybrid of NTN and TN cells.

A WTRU may determine a number of repetitions for PDCCH combining and joint decoding. In some examples, the WTRU may be pre-configured with a number of repetitions that it may combined for PDCCH combining and joint decoding. In some examples, the WTRU may determine the number of repetitions for PDCCH combining implicitly or explicitly based upon any of SSB, eSSB, SIB1, SIB19, resilient notification SIB etc. When the WTRU is configured to perform combining of PDCCH (e.g., over N2 repetitions), the WTRU may know/determine or indicated to combine specific N2 instances of PDCCH. In one example, the WTRU may be configured to combine the first N2 instances of PDCCH (e.g., in first N2 search spaces) of resilient notification SIB window, or for resilient notification alert window. In other examples, the WTRU may be configured to combine N2 instances with an offset from the start of the window, or an offset from the first search space instance in the window, or the last N2 instances etc. The WTRU may further be configured the rules on PDCCH combining candidates, e.g., the candidates of the same aggregation level, the candidates with the same candidate numbering etc. The PDCCH candidates combining rules may further be elaborated as part of the search space linkage as disclosed in one of the embodiments.

A WTRU may monitor, detect, and receive scheduling information for resilient notification system information. The WTRU may monitor the scheduling information based upon its determined parameters to receive resilient notification SIB. The WTRU may receive the scheduling information for resilient notification SIB in the resilient notification SIB window through decoding the PDCCH. The WTRU may monitor the PDCCH in the CORESET and/or search space associated with the resilient notification SIB where the WTRU determination of resilient notification SIB relevant parameters is according to one of the embodiments in this disclosure. As part of the resilient notification SIB parameters, the WTRU may determine the number of PDCCH instances in the same and/or different search spaces it can combine to decode the PDCCH. The WTRU determines the resilient notification SIB window and combines the N2 consecutive PDCCH linked to the detected eSSB. In legacy operation, the network may be transmitting SIB in at least one PDCCH occasion in the SIB window. The WTRU decodes the combined PDCCH with RN_SI RNTI to get the scheduling information for resilient notification SIB.

In an example, the network may be broadcasting resilient notification system information (e.g., broadcasting periodically). The WTRU may determine the configuration parameters necessary to receive resilient notification system information based upon receiving any one or more of SSB, eSSB, and/or SIB1.

A WTRU may request on-demand transmission of resilient notification SIB. In some systems, the network may not be broadcasting resilient notification system information periodically, or the WTRU may not know the configuration to receive resilient notification system information. The WTRU may request on-demand transmission of resilient notification SIB. The WTRU request for on-demand resilient notification SIB may be based upon any one or more of a received SSB, eSSB, and/or SIB1. This may for example be the case when the WTRU is configured to request on-demand transmission of resilient notification SIB based upon SSB, eSSB and/or SIB1. The WTRU request for on-demand resilient notification SIB may be based upon a RACH transmission. When this is the case, the WTRU may determine and/or receive the configuration parameters for RACH transmission based upon any one or more of a received SSB, eSSB, and/or SIB1.

A WTRU may transmit a UL transmission to receive resilient notification SIB (e.g., on-demand resilient notification SIB). The WTRU may transmit the resilient SIB request to the network by transmitting a UL transmission (e.g., a UL RACH transmission). The WTRU may transmit the RACH in the UL direction based upon the received RACH configuration for on-demand resilient notification SIB.

The WTRU may be configured to transmit a request for on-demand resilient notification SIB based upon certain conditions being fulfilled. These conditions may be any one or more of the following conditions.

Conditions may include being based upon WTRU being in a given RRC state. In some examples, the WTRU may be configured to transmit on-demand resilient notification SIB request in an RRC connected state. In other examples, the WTRU may be configured to transmit the request in INACTIVE or in IDLE Mode.

Conditions may include being based upon WTRU being in-coverage or out of coverage. The WTRU may be configured to transmit resilient notification SIB request when the UE is out of coverage. The WTRU may be configured to transmit the resilient notification SIB request while being in coverage.

Conditions may include being based upon DL signal measurement. The WTRU may be configured to transmit a resilient notification SIB request based upon DL signal measurements being better than certain threshold. The DL signals used for measurements may be different based upon WTRU being in-coverage or out-of-coverage. The threshold for signal measurements may be different for a WTRU being in-coverage or out of coverage and based upon WTRU RRC state when the WTRU is in-coverage.

Conditions may include being based upon a WTRU being in a given network location. The WTRU may be configured to transmit a resilient notification SIB request based upon being in a given network location, where the WTRU may be configured to determine the network location based upon suitable parameters (e.g., tracking area, RAN notification area, PLMN, and/or country code).

Conditions may include being based upon a WTRU location. The WTRU may be configured to transmit resilient notification SIB request based upon WTRU location. The WTRU location may correspond to WTRU's determined UE location based upon GNSS or based upon RAT based positioning. The WTRU may be configured to use the reference location received through an NTN beam as WTRU location.

When the WTRU transmits RACH as a request for on-demand resilient notification SIB, the WTRU may use RACH resource according to the RACH configuration. The WTRU may perform timing advance and frequency compensation for its RACH transmission. The timing advance determination and frequency compensation value determination are described in further detail in various embodiments herein.

The WTRU may transmit a RACH message to the network to receive resilient notification SIB. The WTRU may determine the configuration parameters for on-demand resilient notification SIB based upon any one or more of a detected SSB, eSSB, and/or SIB1.

A WTRU may receive resilient notification system information. The WTRU may receive the resilient notification system information by decoding legacy SIBs (e.g., SIB1 and SIB19). This may be achieved by adding the resilient notification system information in any of the legacy SIBs (e.g., SIB1 and/or SIB19). The WTRU may receive the resilient notification system information by decoding a resilient notification SIB. The WTRU may receive and decode the resilient notification SIB based upon a decoded PDCCH, where the WTRU decoding for PDCCH scheduling the resilient notification SIB is according to one of the embodiments in this disclosure. The WTRU may receive the resilient notification system information by decoding the resilient notification PDCCH. This may, for example, be the case when the network is transmitting resilient notification system information embedded in PDCCH.

The system information associated with resilient notification alerts reception may comprise any one or more of the following. Resilient notification configuration where the parameters associated with resilient notification configuration are disclosed in detail in one of the embodiments in this disclosure. RACH configuration to register and/or deregister for resilient notification reception, where this may be the case when the WTRU is expected to register for resilient notification reception based upon the resilient notification SIB. The reference location of the NTN cell and/or beam to be used for time-frequency compensation for RACH transmission, where this may be the case when the WTRU is expected to register for resilient notification reception and the WTRU may be configured to transmit RACH with time-frequency compensation using the reference location of the NTN cell and/or beam. This may be required when the WTRU is expected to transmit in the UL direction (e.g., resilient notification registration and/or UL response to the resilient notification alert).

System information may also include satellite ephemeris information, which may be required and/or useful when the WTRU is expected to transmit in the UL direction (e.g., resilient notification registration and/or UL response to the resilient notification alert) and the WTRU may use the satellite ephemeris information to determine the time advance and/or frequency compensation value. The resilient notification SIB may also include an area scope for resilient notification SIB. The resilient notification SIB may have validity specified with respect to time, network area scope, and/or location area scope. Time validity may include an associated timer, and the WTRU may be configured to consider the resilient notification SIB valid prior to the expiry of this timer. The network area scope may indicate a cell ID (e.g., PCI), a PLMN identity, a tracking area identity, and/or a RAN notification area identity, where the resilient notification SIB may be considered valid. The location area scope of resilient notification SIB may be indicated as a reference location for resilient notification SIB and a distance threshold. The resilient notification SIB may be valid only in and/or around a specific location and/or geographic area.

For example, a resilient notification SIB may have a location area scope indicated as within a 10 km radius for its provided reference geographic coordinates. The location area scope may be more complex areas (e.g., polygons). The location area scope for the resilient notification SIB may be associated with the WTRU location. A resilient notification SIB may be considered valid in terms of its location area scope if the distance of the WTRU location from a reference resilient notification SIB location is less than a threshold. The location area scope of the resilient notification SIB may be associated with the cell and/or beam location from which the WTRU is receiving the signals. If the distance between the resilient notification SIB reference location and the cell and/or beam reference location is less than the distance threshold, the resilient notification SIB is valid within this cell and/or beam.

A WTRU may be configured to receive one of the validities associated with the resilient notification SIB and/or associated with the resilient notification configuration. The WTRU may be configured with a behavior when the WTRU is configured with more than one validity condition for resilient notification configuration and/or resilient notification SIB and one of the configured conditions expires. A WTRU may be configured to consider the resilient notification configuration and/or resilient notification SIB invalid when at least one of the configured validity conditions is not satisfied. System information may also include information for the next satellite supporting resilient notification, information for the suspend/resume of resilient notification, information for the neighboring frequency carrier and/or band supporting resilient notification, information on the WTRU behavior for different levels of availability and/or unavailability of GNSS at the WTRU, information on different resilient notification mechanisms supported by the satellite, and information on how the WTRU may select one of the different resilient notification mechanisms supported by the satellite (e.g., based upon WTRU GNSS availability, based upon WTRU coverage level, and/or based upon WTRU subscription).

A WTRU may register to receive resilient notifications. The WTRU may register to receive resilient notifications based upon a resilient notification configuration, e.g., a suitable resilient notification configuration. The WTRU may register for resilient notification alerts while being in coverage of a cell (e.g., a TN cell and/or an NTN cell). The WTRU may have received one or more resilient notification configurations from the cell and may select a suitable resilient notification configuration for resilient notification registration. In one design, the WTRU may register for resilient notification alerts reception while being in an RRC connected state. The WTRU may send an indication (e.g., an RRC message) to register for resilient notification alerts reception. In another design, the WTRU may register for resilient notification alerts while being in RRC IDLE with a cell. The WTRU may register for resilient notification alerts by transmitting a RACH and may indicate the purpose as resilient notification alerts registration during the RACH procedure.

A WTRU may also register for resilient notification alerts reception while being out of coverage. This may be the case when the WTRU is unable to camp on any cell. In this case, the WTRU may register for resilient notification alerts by transmitting a UL request to the network. The UL request to register may be in the form of a RACH transmission from the WTRU to the network. The WTRU RACH-based resilient notification registration may be based upon any one or more of the following factors. The WTRU may acquire time-frequency synchronization and some basic system information from the SSB. This may be the case when the WTRU is able to detect legacy SSB. The WTRU may acquire time-frequency synchronization and some basic system information from the coverage-extended eSSB. This may be the case when the WTRU is able to detect eSSB, where the WTRU detection of eSSB is according to one of the embodiments in this disclosure. The WTRU may acquire resilient notification system information while being in coverage and/or out of coverage of normal cell operation. The WTRU acquisition of resilient notification system information is according to one of the embodiments in this disclosure.

A WTRU may determine a timing advance value for its UL transmission. The UL transmission may be the WTRU request for resilient notification registration. The UL transmission may also be an UL transmission to the network requesting the transmission of resilient notification system information. This may for example be the case when the resilient notification system information is not being broadcast periodically. The UL transmission may also be an UL resilient notification alert and/or a response to a DL notification alert received by the WTRU. The UL transmission may be an indication transmitted to the network based upon receiving a first-stage resilient notification alert and may form a request to receive a second-stage resilient notification alert. The WTRU may use any one or more of the following to determine the timing advance value. The WTRU may use the satellite ephemeris information to determine the timing advance value for its resilient notification registration request. The WTRU may use the satellite position at a specific time to determine the timing advance value. The WTRU may use its location information to determine the timing advance value. This may be the case when the location information is available at the WTRU (e.g., through GNSS and/or through RAT-based positioning). The WTRU may use the cell and/or beam reference location value to determine the timing advance value. The WTRU may acquire the cell and/or beam reference location as part of the resilient notification system information as disclosed in one of the embodiments in this disclosure.

A WTRU may determine the timing advance value based upon the distance between the satellite and cell and/or beam reference location. This may be the case when the WTRU location is not known and/or not available and the WTRU is expected to perform the time advance assuming the WTRU location as the cell and/or beam reference location. A WTRU may determine the timing advance value based upon WTRU location and cell and/or beam reference location. This may be the case when the WTRU is expected to perform timing advance for the distance between WTRU location and the cell and/or beam reference location, and the network may be handling the timing advance for the distance between the cell and/or beam reference location and the satellite for all UEs. A WTRU may be configured to apply a timing advance value of zero to its UL transmissions (e.g., the registration request for resilient notification reception and/or the UL response to a received DL resilient notification alert).

A WTRU may determine a frequency compensation value to compensate for the frequency Doppler shift of the service link for its UL transmission. The UL transmission may be the WTRU request for resilient notification registration. The UL transmission may also be an UL transmission to the network requesting the transmission of resilient notification system information. This may for example be the case when the resilient notification system information is not being broadcast periodically. The UL transmission may also be an UL resilient notification alert and/or a response to a DL notification alert received by the WTRU. The UL transmission may be an indication transmitted to the network based upon receiving a first-stage resilient notification alert and may serve as a request to receive a second-stage resilient notification alert. The WTRU may use any one or more of the following to determine the frequency compensation value. The WTRU may use the satellite ephemeris information to determine the frequency compensation value for its resilient notification registration request. The WTRU may use any of the satellite position, satellite angular velocity, and/or satellite velocity at a specific time to determine the frequency compensation value. The WTRU may use its location information to determine the frequency compensation value. This may be the case when the location information is available at the WTRU (e.g., through GNSS and/or through RAT-based positioning). The WTRU may use the cell and/or beam reference location value to determine the frequency compensation value. The WTRU may acquire the cell and/or beam reference location as part of the resilient notification system information as disclosed in one of the embodiments in this disclosure.

A WTRU may determine the frequency compensation value based upon the distance between the satellite and cell and/or beam reference location. This may be the case when the WTRU location is not known and/or not available and the WTRU is expected to perform the frequency compensation assuming the WTRU location as the cell and/or beam reference location. A WTRU may be configured to not perform frequency compensation for its UL transmissions (e.g., the registration request for resilient notification reception).

A WTRU may transmit a registration request to receive resilient notification alerts. The WTRU may transmit the resilient notification registration request to the network by transmitting an UL transmission (e.g., an UL RACH transmission). The WTRU may transmit the RACH in the UL direction based upon the received RACH configuration for resilient notification registration, where the WTRU reception of RACH configuration as part of resilient notification system information is disclosed in one of the embodiments in this disclosure. The WTRU may be configured to transmit the resilient notification registration request based upon certain conditions being fulfilled. These conditions may be any one or more of the following. The WTRU may be configured to transmit resilient notification registration in RRC connected state, INACTIVE mode, and/or IDLE mode. The WTRU may be configured to transmit a resilient notification registration request when the WTRU is out of coverage and/or in coverage. The WTRU may be configured to transmit a resilient notification registration request based upon DL signal measurements being better than a certain threshold. The DL signals used for measurements may be different based upon WTRU being in coverage and/or out of coverage. The threshold for signal measurements may be different for WTRU being in coverage and/or out of coverage and based upon WTRU RRC state when the WTRU is in coverage. The WTRU may be configured to transmit a resilient notification registration request based upon being in a given network location, where the WTRU may be configured to determine the network location based upon suitable parameters (e.g., tracking area, RAN notification area, PLMN, and/or country code). The WTRU may be configured to transmit a resilient notification registration request based upon WTRU location. The WTRU location may correspond to the WTRU's determined WTRU location based upon GNSS and/or RAT-based positioning. The WTRU may be configured to use the reference location received through an NTN beam as the WTRU location.

When the WTRU transmits RACH for resilient notification registration, the WTRU may use the RACH resource according to the RACH configuration. The WTRU may perform timing advance and frequency compensation for its RACH transmission, where the timing advance determination and frequency compensation value determination are disclosed in separate embodiments in this disclosure. The WTRU transmits a RACH message to the network to register for resilient notification alerts reception based upon the configuration received in resilient notification SIB.

A WTRU may receive a response from the network. The WTRU may receive a response from the network to its UL transmission. The WTRU UL transmission may correspond to a request to register for resilient notification services. The network response may complement, update, and/or overwrite some or all of the parameters of the resilient notification monitoring configuration that the WTRU may have. The network response to the WTRU registration request may provide the WTRU with a resilient notification identity with which the WTRU may be notified for a resilient notification alert in the future. The WTRU resilient notification identity may be based upon an identity and/or assignment of a bit in a bitmap. The details on WTRU resilient notification identity are disclosed in one of the embodiments in this disclosure. The network may complement, add, update, and/or overwrite some or all of the parameters of resilient notification system information and/or resilient notification monitoring configuration. The WTRU may be configured to retransmit a UL registration request if it does not receive a network response within a configured duration and until a certain number of retransmissions have been made. The WTRU may be configured to consider the registration successful based upon receiving a response from the network to its UL RACH transmission. This may be the case when the WTRU transmission is for a 2-step RACH procedure and/or the WTRU performs RACH based upon a contention-free RACH configuration. The WTRU may be configured to proceed after receiving the network response to Step 3 and Step 4 of the RACH procedure to perform contention resolution. This may be the case when the WTRU is performing RACH transmission based upon a contention-based RACH procedure.

A WTRU may determine one or more parameters associated with the resilient notification monitoring configuration. The parameters associated with the resilient notification monitoring configuration are disclosed in one of the embodiments in this disclosure. The WTRU may determine one or more parameters of the resilient notification monitoring configuration based upon one or more of the following factors. The WTRU may determine one or more parameters of the resilient notification monitoring configuration based upon a detected SSB. The detected SSB may provide any one or more of the following: a time-frequency reference, SFN timing that can provide the basis for resilient notification SIB, resilient notification registration request, and/or resilient notification monitoring frame/occasions. A detected SSB may provide the complete resilient notification configuration without any additional signaling from the network. This may be the case when the WTRU determines the resilient notification frame/occasion timing based upon SFN and some known mapping (e.g., the WTRU may be configured to determine the occurrence of a resilient notification frame in a given SFN and/or the occurrence of a resilient notification occasion in a given slot). The WTRU may be configured to monitor resilient notification alerts in the CORESET 0/search space 0 as indicated in the PBCH, part of the detected SSB. In addition to the resilient notification CORESET/search space determination based upon CORESET 0/search space 0, the WTRU may be configured to determine a number of repetitions for PDCCH associated with resilient notification alerts based upon the detected SSB. The detected SSB may provide an explicit and/or implicit indication for the PDCCH repetitions that the WTRU may combine to decode the PDCCH. The WTRU may either have been pre-configured for search space linkage and/or indicated explicitly and/or implicitly through the detected SSB.

A WTRU may determine one or more parameters of the resilient notification monitoring configuration based upon a detected eSSB. The detected eSSB may provide any one or more of the following: a time-frequency reference and SFN timing that can provide the basis for resilient notification SIB, resilient notification registration request, and/or resilient notification monitoring frame/occasions. An eSSB alone may provide the complete resilient notification configuration without any additional signaling from the network. This may be the case when the WTRU determines the resilient notification frame/occasion timing based upon SFN and some known mapping (e.g., the WTRU may be configured to determine the occurrence of a resilient notification frame in a given SFN and/or the occurrence of a resilient notification occasion in a given slot). Furthermore, the WTRU may be configured to monitor resilient notification alerts in the CORESET/search space as indicated in the eSSB. The CORESET/search space indication in the eSSB may be the same as indicated in the SSB and/or may be different from CORESET 0/search space 0 indicated in the SSB. The detected eSSB may provide an explicit and/or implicit indication for the PDCCH repetitions that the WTRU may combine to decode the PDCCH associated with resilient notification alert reception. The WTRU may have been pre-configured for search space linkage and/or indicated explicitly and/or implicitly through the detected eSSB.

A resilient notification SIB may provide full and/or partial configuration parameters of the resilient notification monitoring configuration. The resilient notification SIB may complement, update, and/or overwrite some or all of the parameters of the resilient notification configuration that the WTRU may have received earlier. The network may provide the resilient notification monitoring configuration to the WTRU while the WTRU is in coverage. The WTRU may have received the configuration while being in RRC connected, inactive, and/or idle mode. When the WTRU is expected to register for resilient notification alerts, the network may provide a resilient notification configuration as part of the response to the WTRU registration request. The WTRU may receive some, any, and/or all of the parameters of the resilient notification monitoring configuration while subscribing to resilient notification alerts. The WTRU may determine the resilient notification monitoring configuration based upon the frequency band of operation, the frequency range (e.g., FR1, FR2, and/or FR3), the sub-carrier spacing of a detected SSB and/or detected eSSB, the sub-carrier spacing common indicated in a detected SSB and/or eSSB, and/or the ARFCN value.

A WTRU may determine the type of resilient notification alerts to monitor based upon WTRU capability, network capability, and resilient notification monitoring configuration. The WTRU may also determine the type of resilient notification alerts to monitor based upon any one or more of the following factors: the type of satellite (e.g., LEO, MEO, and/or GEO), the WTRU battery status, the WTRU temperature, and/or WTRU monitoring for alerts where UL alerts are required or not.

A WTRU may monitor resilient notification alerts based upon the determined parameters of the resilient notification monitoring configuration, where the determination of resilient notification parameters is according to one of the embodiments in this disclosure. The WTRU may monitor resilient notification alerts in combination with one or more of the following factors. The WTRU may be configured to monitor resilient notification alerts based upon a detected SSB. When this is the case, the resilient notification monitoring configuration may indicate resilient notification frame/occasion alignment with the SSB. The alignment of SSB with resilient notification frames/occasions may help the WTRU acquire time-frequency synchronization, facilitating resilient notification alert detection and/or decoding. The WTRU may be configured to monitor resilient notification alerts based upon a detected eSSB. When this is the case, the resilient notification monitoring configuration may indicate resilient notification frame/occasion alignment with the eSSB. The alignment of eSSB with resilient notification frames/occasions may help the WTRU acquire time-frequency synchronization, facilitating resilient notification alert detection and/or decoding. The WTRU may be configured to monitor resilient notification alerts based upon a detected resilient notification SIB configuration. The WTRU may be monitoring resilient notification alerts in the resilient notification SIB monitoring window (e.g., using the resilient notification SIB CORESET and search space). The WTRU may be provided with one single configuration to receive resilient notification SIB and monitor resilient notification alerts. The WTRU may perform resilient notification PDCCH combining based upon the resilient notification monitoring configuration and/or resilient notification search space configuration. The WTRU may perform resilient notification PDSCH decoding and resilient notification PDSCH combining based upon the resilient notification monitoring configuration and/or indications in the resilient notification PDCCH.

A WTRU may receive an early indication for resilient notification alerts in the same CORESET/search space as configured to monitor resilient notification alerts. The early indication may be specific to a WTRU and/or a group of WTRUs. The early indication may be associated with an incoming resilient notification alert for a group of UEs. Based upon receiving the early indication, the WTRU may monitor the subsequent resilient notification monitoring occasions. Based upon the early resilient notification indication, the WTRU may determine any one or more of the following: to read and/or monitor a short message-based WTRU-specific alert, to receive full resilient notification paging in a subsequent occasion, to read and/or monitor a short message-based group-specific alert, and/or to apply/use specific parameters to monitor resilient notification alerts (e.g., use a specific number of PDCCH combining and/or use a specific combining type for PDCCH indicating the resilient notification alerts).

A WTRU may receive a short message-based resilient notification alert specific to the WTRU by decoding a PDCCH with a specific RNTI (e.g., RN_RNTI) and based upon detecting the WTRU-assigned short message bit set to a specific value, where the WTRU may have been assigned the bit and configured to detect an resilient notification alert when the WTRU-assigned bit is set to that specific value. The WTRU may be configured to monitor resilient notification alert PDCCH in the same and/or different search space as used for resilient notification SIB detection. The WTRU may be configured to use an RN_RNTI to decode the PDCCH and/or to use the paging RNTI to decode the PDCCH. The WTRU may receive a short message-based resilient notification alert by decoding a bitmap in the PDSCH. This may be the case when the network configures the WTRU to monitor for resilient notification alerts based upon an assigned bit in the bitmap, and the WTRU is configured to receive the bitmap in the resilient notification PDSCH. The WTRU will monitor resilient notification alerts and decode the resilient notification PDCCH to obtain the scheduling information for resilient notification PDSCH. The WTRU then decodes the PDSCH to obtain the resilient notification bitmap. The WTRU may declare receiving a resilient notification alert based upon the status of its assigned bit.

A WTRU may be configured to determine a positive resilient notification alert reception based upon receiving a specific value in the WTRU assigned bit (e.g., a value of 1 or a value of 0). The WTRU may detect an alert based upon a change in the value of the WTRU assigned bit compared to the previously detected value (e.g., from 0 to 1 and/or from 1 to 0). The WTRU may also be configured to receive a positive resilient notification alert based upon detecting a specific value of the WTRU assigned bit within a configured duration (e.g., receiving a value of 1 at least four times in ten hyper-SFNs).

A WTRU may receive a resilient notification alert. The WTRU may be configured to receive a resilient notification alert based upon a decoded PDSCH. The WTRU may monitor and receive PDCCH based upon resilient notification configuration to receive the scheduling information for resilient notification PDSCH. The WTRU may use a resilient notification RNTI (RN_RNTI) to decode the PDCCH. In some examples, the WTRU may use the paging RNTI to decode the PDCCH. The WTRU may decode the resilient notification PDSCH based upon the scheduling information received in the resilient notification PDCCH and may perform repetition combining based upon the configuration and/or indication in the decoded PDCCH.

A WTRU may decode a short message-based resilient notification PDCCH. The WTRU may be configured to monitor and decode a group common short message-based resilient notification PDCCH and may further decode a resilient notification PDSCH to receive the second stage of the resilient notification alert.

A WTRU may be configured to monitor and receive two-stage resilient notification alerts. The WTRU may be configured to monitor and decode two-stage resilient notification alerts where a first-stage resilient notification alert may be a group common resilient notification alert. The group common alert may be transmitted through a short message (e.g., assigning the bits in a bitmap to different WTRU groups). The WTRU may detect a positive indication for its group by detecting a short message-based group alert for its assigned bit.

Based upon the reception of a group-based alert, the WTRU may be configured to indicate the group alert reception to its human user. The WTRU may further determine whether to monitor for a second-level alert based upon human user feedback (e.g., if the human user is interested in validating the alert). The WTRU may determine whether to monitor the second-stage alert based upon WTRU battery levels, WTRU resilient notification subscription, and/or resilient notification configuration.

A WTRU may be configured to receive a first-stage alert in a detected resilient notification PDCCH, where the scheduling information in the decoded PDCCH may be for the resilient notification PDSCH carrying the second-stage alert. This may be the case when the resilient notification PDCCH carries both the group-based short message indication and the time-frequency scheduling information for resilient notification PDSCH. In another design, a WTRU may be configured to receive a first-stage alert in a detected resilient notification PDCCH and receive the second-stage alert in a subsequent resilient notification frame/occasion. This may be the case when the resilient notification PDCCH carries the group-based short message resilient notification indication in one resilient notification frame/occasion, while the resilient notification PDCCH in a subsequent frame/occasion provides the time-frequency scheduling information for the resilient notification PDSCH carrying the second-stage alert.

A WTRU may determine an action after receiving a resilient notification alert. The WTRU determination for the subsequent action may be based upon one or more factors, including the type of resilient notification alert, the content of the resilient notification alert, the WTRU resilient notification subscription, and the WTRU capability to transmit and/or indicate an UL resilient notification response. Based upon a received resilient notification alert, the WTRU may be configured to perform one or more actions, such as indicating reception of the resilient notification alert (e.g., by playing a sound and/or beep for a human user), transmitting an UL resilient response, and/or initiating a co-operative user detection procedure.

A WTRU may perform an UL transmission based upon a received positive resilient notification alert. The WTRU may be configured to perform an UL transmission according to one or more of the following: transmitting a contention-based and/or contention-free RACH transmission with a given number of repetitions (where the RACH configuration may be indicated in resilient notification SIB and/or resilient notification configuration) and/or performing a two-step RACH transmission to indicate the WTRU UL resilient notification response.

A WTRU may determine that it is a co-operative user after receiving a positive resilient notification alert based upon the resilient notification configuration. The WTRU may be configured to determine co-operative user status based upon detection of improved coverage, which may be identified through measurements of suitable DL signals (e.g., SSB and/or eSSB). The WTRU may need to validate co-operative user status within a specific time frame, and this determination may depend on the nature, type, priority, and/or severity of the resilient notification alert received.

A WTRU may be configured to provide an indication to the network if it determines itself to be a co-operative user. Additionally, based upon the nature, type, priority, and/or severity of the received resilient notification alert, the WTRU may be configured to provide an indication to the network as soon as it can initiate an UL transmission.

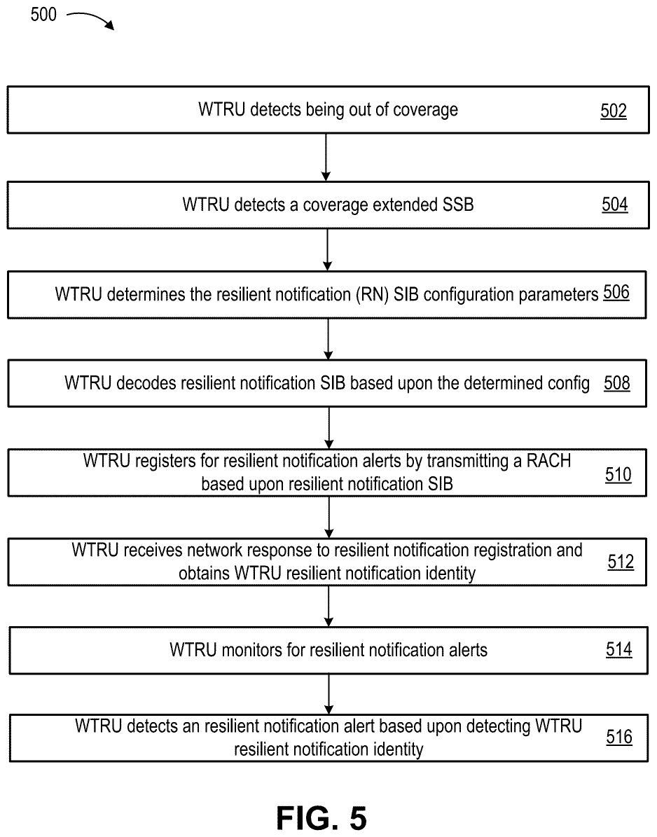

Referring now to FIG. 5, a diagram showing an example method 500 for receiving resilient notification (RN) alerts with an alternative configuration is illustratively depicted.

At 502, the WTRU may detect being out of coverage. At 504, the WTRU may detect a coverage-extended Synchronization Signal Block (eSSB). At 506, the WTRU may determine the resilient notification (RN) system information block (SIB) configuration parameters.

At 508, the WTRU may decode the resilient notification SIB based on the determined configuration. At 510, the WTRU may register for resilient notification alerts by transmitting a random access channel (RACH) message based on the resilient notification SIB. At 512, the WTRU may receive a network response to resilient notification registration and obtain the WTRU resilient notification identity. At 514, the WTRU may monitor for resilient notification alerts. At 516, the WTRU may detect a resilient notification alert based on detecting the WTRU resilient notification identity.

In examples, a WTRU may register for resilient notification alerts when experiencing extremely poor channel conditions (e.g., 15-25 dB worse than normal NTN operation). The WTRU may register for resilient notification alerts based upon a coverage-extended SSB/SIB despite having no and/or limited GNSS and may monitor for resilient notification alerts in a WTRU-specific short message format. A WTRU may detect being out of coverage (e.g., when SSB RSRP is below a threshold and/or no SSB is detected at all). The WTRU may detect a coverage-extended SSB (e.g., an eSSB with N1 repetitions, either consecutive and/or with a known shorter periodicity). Based upon the detected eSSB and its content, the WTRU may determine the configuration needed to receive a resilient notification SIB, including timing window, CORESET, search space, and/or PDCCH repetitions (N2). The WTRU may determine the resilient notification SIB window and combine the N2 consecutive PDCCH instances linked to the detected eSSB.

The WTRU may decode the resilient notification SIB PDSCH based upon scheduling information received in the decoded PDCCH to obtain the RACH configuration for registering and/or deregistering for resilient notification reception, the reference location of the NTN cell and/or beam to be used for time-frequency compensation for RACH, limited satellite ephemeris information, the resilient notification monitoring configuration, and the area scope for resilient notification SIB. The WTRU may then transmit a RACH message to the network to register for resilient notification reception based upon the configuration received in the resilient notification SIB. The WTRU may use the reference location from the resilient notification SIB to perform time-frequency compensation of the RACH message without needing to know its own location. Upon receiving a response from the network, the WTRU may be assigned a resilient notification identity (e.g., a specific bit in a bitmap), to monitor resilient notification alerts. The WTRU may then monitor the resilient notification channel based upon the eSSB and resilient notification monitoring configuration from the resilient notification SIB. The WTRU may decode a PDCCH based upon the resilient notification monitoring configuration and, upon detecting its assigned resilient notification identity (e.g., a WTRU assigned bit set), may determine that a resilient notification alert has been received.

A WTRU may be able to detect a normal SSB but be unable to receive SIBs and/or camp on any cell. The WTRU may have a resilient notification alert subscription and may register for resilient notification alerts to enable the WTRU to monitor and/or receive resilient notification alerts. A WTRU may register for resilient notification alerts based upon a detected SSB and may receive extended coverage system information based upon the detected SSB before registering for resilient notification reception. The WTRU may determine that it is out of coverage (e.g., by failing to receive system information) (e.g., SIB1 and/or SIB19), for a detected SSB. Based upon the detected SSB, the WTRU may determine the configuration needed to receive a coverage-extended resilient notification SIB, including timing, timing window, CORESET, search space, and PDCCH repetitions (N2). The parameters detected with the SSB (e.g., SFN timing), may indicate the occurrence of a timing window where coverage-extended SIBs are transmitted. The determination of coverage-extended SIB configuration via SSB may be implicit (e.g., WTRU derives based upon SFN), and/or explicit (e.g., an explicit bit in MIB and/or PBCH payload) and/or through DMRS/sequence-based signaling.

The WTRU may receive and/or decode the coverage-extended PDCCH based upon the determined resilient notification SIB configuration. The WTRU may decode the PDCCH after combining the determined N2 repetitions to obtain the scheduling information for the coverage-extended SIB. The WTRU may decode the coverage-extended resilient notification SIB PDSCH based upon the scheduling information received in the decoded PDCCH. The resilient notification SIB may provide the RACH configuration for registering, deregistering, and/or monitoring for resilient notification, the reference location of the NTN cell and/or beam for time-frequency compensation, limited satellite ephemeris information, the resilient notification monitoring configuration, and/or the area scope for resilient notification SIB.

The WTRU may transmit a RACH message to the network to register for resilient notification alert reception based upon the RACH configuration received in the resilient notification SIB. Upon receiving a response from the network, the WTRU may be assigned, by the network, a resilient notification identity (e.g., a specific bit in a bitmap), to monitor resilient notification alerts. The WTRU may monitor the resilient notification channel based upon the SSB and resilient notification monitoring configuration from the resilient notification SIB. The WTRU may decode a PDCCH based upon the resilient notification monitoring configuration and, based upon detecting the WTRU assigned resilient notification identity (e.g., WTRU assigned bit set), the WTRU may detect a resilient notification alert.

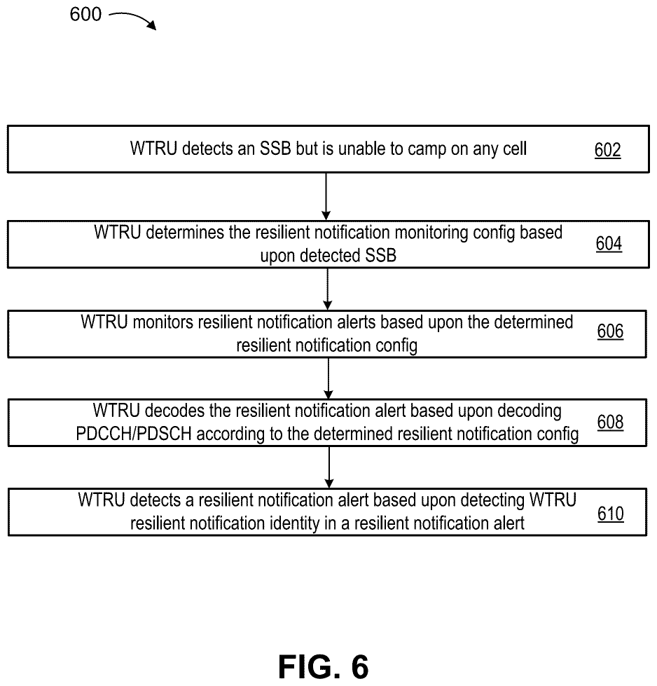

Referring now to FIG. 6, a method 600 for detecting and/or decoding resilient notification alerts is illustratively depicted. At 602, the WTRU may detect an SSB but may be unable to camp on any cell. At 604, the WTRU may determine the resilient notification monitoring configuration based on the detected SSB. At 606, the WTRU may monitor resilient notification alerts based on the determined resilient notification configuration. At 608, the WTRU may decode the resilient notification alert based on decoding PDCCH/PDSCH according to the determined resilient notification configuration. At 610, the WTRU may detect a resilient notification alert based on detecting the WTRU resilient notification identity in a resilient notification alert.

A WTRU may be able to detect a normal SSB but be unable to receive SIBs and/or camp on any cell. The WTRU may have a resilient notification alert subscription and may know an identity against which the network may send a resilient notification alert. The WTRU may acquire resilient notification monitoring configuration by reading an extended coverage SIB.

A WTRU may monitor and/or receive resilient notification alerts when it detects a legacy SSB but cannot camp due to missing system information (e.g., SIB1 and/or SIB19). The WTRU may receive extended coverage system information based upon the detected SSB. Upon receiving the resilient notification configuration through an extended coverage SIB, the WTRU may begin monitoring for resilient notification alerts. The WTRU may determine being out of coverage (e.g., based upon failing to receive system information (e.g., SIB1 and/or SIB19) for a detected SSB. Based upon the detected SSB, the WTRU may determine the configuration needed to receive a coverage-extended resilient notification SIB, including timing, timing window, CORESET, search space, and PDCCH repetitions (N2).

The WTRU may receive and decode the coverage-extended PDCCH based upon the determined configuration to obtain scheduling information for resilient notification SIB PDSCH. The WTRU may then decode the resilient notification SIB PDSCH based upon the received scheduling information from the decoded PDCCH. The resilient notification SIB PDSCH may provide the resilient notification monitoring configuration and validity information (e.g., time validity and/or network area). The WTRU may monitor the resilient notification channel based upon the SSB and resilient notification monitoring configuration from the resilient notification SIB. The WTRU may decode a PDCCH based upon the resilient notification monitoring configuration and, based upon detecting a known identity (e.g., WTRU resilient notification identity), the WTRU may detect receiving a resilient notification alert.

A WTRU may be able to detect normal SSB but may not be able to receive SIBs (e.g., SIB1, SIB19, etc.) to camp. The WTRU may have a resilient notification alert subscription and may know a WTRU identity against which the network may send a resilient notification alert. The WTRU may need to acquire a resilient notification monitoring configuration by reading extended coverage SIB. In examples, a WTRU may be enabled to monitor and receive resilient notification alerts when it can detect a legacy SSB but cannot camp due to missing system information (e.g., SIB1/SIB19). The WTRU may receive extended coverage resilient notification system information embedded in PDCCH based upon the detected SSB. Based upon the resilient notification configuration received through resilient notification system information, the WTRU may begin to monitor resilient notification alerts.

The WTRU may determine that it is out of coverage (e.g., based upon failing to receive system information (e.g., SIB1, SIB19, etc.)) for a detected SSB. Based upon the detected SSB, the WTRU may determine the configuration needed to receive coverage extended resilient notification system information embedded in PDCCH (e.g., timing, timing window, CORESET, search space, and/or PDCCH repetitions N2).

The WTRU may receive and/or decode the coverage extended PDCCH based upon the determined configuration. Based on the decoded PDCCH, the WTRU may determine one or more of a resilient notification monitoring configuration and/or validity information for resilient notification system information (e.g., based upon a timer, network area, and/or WTRU location). The WTRU may monitor the resilient notification channel based upon the SSB and the resilient notification monitoring configuration. To receive a resilient notification alert, the WTRU may decode a PDCCH based upon the resilient notification monitoring configuration, and based upon detecting a known WTRU identity (e.g., a WTRU resilient notification identity), the WTRU may detect receiving a resilient notification alert.

A WTRU may be able to detect a normal SSB but be unable to detect SIBs and/or camp on any cell. The WTRU may have a resilient notification alert subscription and may know a resilient notification identity against which the network may send a resilient notification alert. The WTRU may have been pre-registered to receive resilient notification alerts, and/or the network may systematically transmit resilient notification alerts for WTRUs failing to respond to normal paging. The WTRU may monitor and receive resilient notification alerts based upon a detected SSB and a default resilient notification configuration.

A WTRU may determine that it is out of coverage (e.g., based upon failing to receive system information (e.g., SIB1 and/or SIB19)) for a detected SSB. Based upon the detected SSB, the WTRU may determine the configuration needed to receive resilient notifications. The parameters detected with the SSB (e.g., SFN timing, CORESET 0, and/or SS0), combined with a WTRU identity (e.g., IMSI, IMEI, and/or a global WTRU resilient notification identity assigned to the WTRU when it registered for resilient notification subscription), may indicate the occurrence of a timing window where coverage-extended resilient notification alerts may be transmitted. As an example, a given set of frames and/or sub-frames repeating with a large periodicity (e.g., one or more hyper-frames) may be used to transmit coverage-extended resilient notification alerts with additional repetitions.

The WTRU may monitor, receive, and/or decode the coverage-extended PDCCH based upon the determined configuration. The WTRU may decode the PDCCH after combining a number of repetitions based upon its determined configuration. The WTRU may decode the coverage-extended resilient notification PDSCH based upon the decoded PDCCH (e.g., time-frequency resource, DMRS, and/or combining/repetitions). The WTRU may determine a positive resilient notification alert if one of the records in the resilient notification message matches the WTRU resilient notification identity.

1. A wireless transmit/receive unit (WTRU) comprising a processor configured to:
receive a coverage extended synchronization signal block (eSSB);
based on the receiving of the eSSB, determine a configuration associated with a resilient notification system information block (SIB) window;
receive a resilient notification SIB during the resilient notification SIB window based on the configuration associated with the resilient notification SIB window;
monitor a resilient notification channel based on the eSSB and the resilient notification SIB; and
receive, via the resilient notification channel, a resilient notification alert message that comprises an identity of the WTRU.

2. The WTRU of claim 1, wherein the eSSB is a coverage-extended SSB based on a normal SSB structure that is transmitted with one or more of a shorter periodicity, additional repetitions, or a modified transmission pattern as compared to a normal SSB.

3. The WTRU of claim 1, wherein the processor is configured to:
receive configuration information associated with the eSSB based on one or more of a previously stored configuration, neighbor cell information, or upon failure to detect a coverage-resume signal.

4. The WTRU of claim 1, wherein the processor is configured to:
determine a subframe number, a control resource set (CORESET), or a search space (SS) based on the eSSB, wherein the configuration of the resilient notification SIB window is based on one or more of the subframe number, the CORESET, or the SS.

5. The WTRU of claim 1, wherein the configuration associated with the resilient notification SIB window indicates one or more of a periodicity of the resilient notification SIB window, a duration of the resilient notification SIB window, a CORESET associated with the resilient notification SIB window, a search space associated with the resilient notification SIB window, physical downlink control channel (PDCCH) repetition and combining parameters associated with the resilient notification SIB window, or physical downlink shared channel (PDSCH) repetition and combining parameters associated with the resilient notification SIB window.

6. The WTRU of claim 1, wherein the processor is configured to:
determine that the resilient notification SIB is transmitted in a physical downlink control channel (PDCCH) during the resilient notification SIB window based on one or more of PDCCH repetition and combining parameters, or physical downlink shared channel (PDSCH) repetition and combining parameters, as provided by the configuration associated with the resilient notification SIB window, wherein the resilient notification SIB window comprises a plurality of PDCCH occasions.

7. The WTRU of claim 1, wherein the processor is configured to:
determine the configuration associated with the resilient notification SIB window after failing to detect any normal SSB.

8. The WTRU of claim 1, wherein the resilient notification SIB comprises a resilient notification monitoring configuration; and
wherein the processor is configured to:
monitor the resilient notification channel based on the resilient notification monitoring configuration, wherein the resilient notification monitoring configuration comprises one or more of a periodicity for resilient notification alert monitoring, a CORESET associated with the resilient notification channel, a search space for resilient notification monitoring, or physical downlink control channel (PDCCH) repetition parameters for resilient notification alert reception.

9. The WTRU of claim 1, wherein the processor is configured to:
receive a physical downlink control channel (PDCCH) associated with the resilient notification SIB;
receive scheduling information for a physical downlink shared channel (PDSCH) associated with the resilient notification SIB by decoding the PDCCH;
receive the PDSCH based on the scheduling information;
receive a resilient notification monitoring configuration from the PDSCH; and
monitor for resilient notification alerts based on the resilient notification monitoring configuration.

10. The WTRU of claim 1, wherein the resilient notification channel is one or more of a physical downlink control channel (PDCCH) or a physical downlink shared channel (PDSCH) based upon the configuration received in the resilient notification SIB; and
wherein the resilient notification SIB indicates uplink resources for use by the WTRU, wherein the uplink resources include physical random access channel (PRACH) or physical uplink control channel (PUCCH) resources to enable the WTRU to respond to the resilient notification alert messages.

11. A method performed by a wireless transmit/receive unit (WTRU), the method comprising:
receiving a coverage extended synchronization signal block (eSSB);
based on the receiving of the eSSB, determining a configuration associated with a resilient notification system information block (SIB) window;
receiving a resilient notification SIB during the resilient notification SIB window based on the configuration associated with the resilient notification SIB window;
monitoring a resilient notification channel based on the eSSB and the resilient notification SIB; and
receiving, via the resilient notification channel, a resilient notification alert message that comprises an identity of the WTRU.

12. The method of claim 11, wherein the eSSB is a coverage-extended SSB based on a normal SSB structure that is transmitted with one or more of a shorter periodicity, additional repetitions, or a modified transmission pattern as compared to a normal SSB.

13. The method of claim 11, further comprising:
receiving configuration information associated with the eSSB based on one or more of a previously stored configuration, neighbor cell information, or upon failure to detect a coverage-resume signal.

14. The method of claim 11, further comprising:
determining one or more of a subframe number, a control resource set (CORESET), or a search space (SS) based on the eSSB, wherein the configuration of the resilient notification SIB window is based on one or more of the subframe number, the CORESET, or the SS.

15. The method of claim 11, wherein the configuration associated with the resilient notification SIB window indicates one or more of a periodicity of the resilient notification SIB window, a duration of the resilient notification SIB window, a CORESET associated with the resilient notification SIB window, a search space associated with the resilient notification SIB window, physical downlink control channel (PDCCH) repetition and combining parameters associated with the resilient notification SIB window, or physical downlink shared channel (PDSCH) repetition and combining parameters associated with the resilient notification SIB window.

16. The method of claim 11, further comprising:
determining that the resilient notification SIB is transmitted in a physical downlink control channel (PDCCH) during the resilient notification SIB window based on one or more of PDCCH repetition and combining parameters, or physical downlink shared channel (PDSCH) repetition and combining parameters, as provided by the configuration associated with the resilient notification SIB window, wherein the resilient notification SIB window comprises a plurality of PDCCH occasions.

17. The method of claim 11, further comprising:
determining the configuration associated with the resilient notification SIB window after failing to detect any normal SSB.

18. The method of claim 11, wherein:
the resilient notification SIB comprises a resilient notification monitoring configuration; and
wherein the method further comprises:
monitoring the resilient notification channel based on the resilient notification monitoring configuration, wherein the resilient notification monitoring configuration comprises one or more of a periodicity for resilient notification alert monitoring, a CORESET associated with the resilient notification channel, a search space for resilient notification monitoring, or physical downlink control channel (PDCCH) repetition parameters for resilient notification alert reception.

19. The method of claim 11, further comprising:
receiving a physical downlink control channel (PDCCH) associated with the resilient notification SIB;
receiving scheduling information for a physical downlink shared channel (PDSCH) associated with the resilient notification SIB by decoding the PDCCH;
receiving the PDSCH based on the scheduling information;
receiving a resilient notification monitoring configuration from the PDSCH; and
monitoring for resilient notification alerts based on the resilient notification monitoring configuration.

20. The method of claim 11, wherein the resilient notification channel is one or more of a physical downlink control channel (PDCCH) or a physical downlink shared channel (PDSCH) based upon the configuration received in the resilient notification SIB; and
wherein the resilient notification SIB indicates uplink resources for the WTRU, wherein the uplink resources comprise physical random access channel (PRACH) or physical uplink control channel (PUCCH) resources to enable the WTRU to respond to the resilient notification alert messages.
